(19) United States
(12) Patent Application Publication
(10) Pub. No.: US 2026/0251104 A1
(43) Pub. Date: Aug. 27, 2026

(54) Internal Combustion Engine Control Device and Control System for Mobile Object

(71) Applicant: Astemo, Ltd., Chiyoda-ku, Tokyo (JP)

(72) Inventors: Eiichiro OHATA, Hitachinaka-shi, Ibaraki (JP); Kunihiko SUZUKI, Hitachinaka-shi, Ibaraki (JP); Takeo TAKAHASHI, Hitachinaka-shi, Ibaraki (JP)

(21) Appl. No.: 19/159,360

(22) PCT Filed: Mar. 31, 2023
(86) PCT No.: PCT/JP2023/013478

§ 371 Date: Aug. 25, 2025

(51) Int. Cl. F02D 43/04; F02D 41/00; F02D 41/14; F02D 41/30; F02P 5/15

(52) U.S. Cl. CPC F02D 43/04; F02D 41/0002; F02D 41/0047; F02D 41/1454; F02D 41/30; F02P 5/1502

(57) ABSTRACT

An object is to appropriately control heat balance of an ignition device to suppress increase in size and cost of the ignition device. An internal combustion engine control device controls an internal combustion engine for a mobile object, the internal combustion engine including: an intake device that guides intake air into a cylinder through an intake passage; a fuel supply device that supplies fuel; and an ignition device that ignites an air-fuel mixture including the intake air and the fuel. The internal combustion engine control device includes an ignition device temperature estimation unit and an adjuster. The ignition device temperature estimation unit measures or estimates current temperature of the ignition device and estimates future temperature that is temperature of the ignition device on a future path based on information on a current state of the mobile object. The adjuster adjusts a control instruction of at least any one of the ignition device, the fuel supply device, and the intake device in accordance with the current temperature and the future temperature.

### TECHNICAL FIELD

The present invention relates to an internal combustion engine control device and a control system for a mobile object.

### BACKGROUND ART

In recent years, techniques have been developed to improve fuel efficiency of an internal combustion engine in a mobile object such as a vehicle, the techniques including: a lean combustion technique in which an air-fuel mixture larger than a theoretical air-fuel ratio (thin fuel) is combusted and operated; and an exhaust gas recirculation technique (dilution combustion technique) in which a part of an exhaust gas after combustion is diluted with air (intake air of the internal combustion engine), and this diluted exhaust gas is taken for another intake.

When this type of lean combustion, dilution combustion, or the like is performed in an internal combustion engine, sparks are less likely to fly to an ignition plug due to use of an air-fuel mixture with thin fuel and implementation of the exhaust gas recirculation. Thus, ignition capability (i.e., the amount of ignition energy) of an ignition device required for flame formation in a combustion chamber is increased as compared with when an air-fuel mixture of a theoretical air-fuel ratio is ignited. Consequently, a calorific value of an ignition coil per unit time increases.

For example, PTL 1 discloses an engine ignition device configured to correct ignition energy in accordance with a change in pressure in an intake pipe. The engine ignition device disclosed in PTL 1 increases ignition energy by extending energization time of an ignition coil based on intake pipe pressure Pm to prevent a misfire during supercharging. Consequently, a stable combustion state is secured even in a situation where sparks are less likely to fly to the ignition plug due to the supercharging.

### CITATION LIST

### Patent Literature

PTL 1: JP 2000-054941 A

### SUMMARY OF INVENTION

### Technical Problem

Unfortunately, the engine ignition device disclosed in PTL 1 does not consider heat balance of the ignition coil. For example, when the internal combustion engine is operated at a high load and continuously under the pressure Pm of the intake pipe increased by the supercharging, the energization time to the ignition coil is extended. Consequently, the ignition device maintains a situation in which the ignition energy is increased, that is, a situation in which the calorific value per unit time is large. As a result, temperature of the ignition device may exceed a preset rated temperature.

Conceivable examples of a countermeasure against such a problem include heat dissipation design of the ignition coil in consideration of duration of high-load continuous operation, or in consideration of not only a maximum condition of the calorific value per unit time of the ignition coil when lean combustion or dilution combustion is performed, for example, but also a severe environmental condition such as when outside temperature is high in the summer season. Unfortunately, this countermeasure causes new problems such as increase in size of the ignition device and increase in cost.

In view of the above problems, it is an object of the present invention to provide an internal combustion engine control device and a control system for a mobile object that appropriately control heat balance of an ignition device and suppress increase in size and cost of the ignition device.

### Solution to Problem

To solve the above problems and achieve the present object, an internal combustion engine control device according to an aspect of the present invention controls an internal combustion engine for a mobile object, the internal combustion engine including: an intake device that guides intake air into a cylinder through an intake passage; a fuel supply device that supplies fuel; and an ignition device that ignites an air-fuel mixture including the intake air and the fuel. The internal combustion engine control device includes an ignition device temperature estimation unit and an adjuster. The ignition device temperature estimation unit measures or estimates current temperature of the ignition device and estimates future temperature that is temperature of the ignition device on a future path based on information on a current state of the mobile object. The adjuster adjusts a control instruction of at least any one of the ignition device, the fuel supply device, and the intake device in accordance with the current temperature and the future temperature.

A control system for a mobile object according to an aspect of the present invention includes: an internal combustion engine control device that controls an internal combustion engine for a mobile object, the internal combustion engine including an intake device that guides intake air into a cylinder through an intake passage, a fuel supply device that supplies fuel, and an ignition device that ignites an air-fuel mixture including the intake air and the fuel; and a communication device that mediates communication between an external device outside the mobile object and the internal combustion engine control device. The internal combustion engine control device includes an ignition device temperature estimation unit, an adjuster, and a current parameter observation unit. The ignition device temperature estimation unit measures or estimates current temperature of the ignition device and estimates future temperature that is temperature of the ignition device on a future path based on information on a current state of the mobile object. The adjuster adjusts a control instruction of at least any one of the ignition device, the fuel supply device, and the intake device in accordance with the current temperature and the future temperature. The current parameter observation unit measures or estimates a current parameter related to a current state of the mobile object. The adjuster includes a prediction parameter acquisition unit and a future parameter prediction unit. The prediction parameter acquisition unit acquires a prediction parameter regarding a state of the mobile object on the future path through communication connection to the external device using the communication device. The future parameter prediction unit predicts a plurality of future parameters related to the state of the mobile object on the future path based on the prediction parameter and the current parameter. Then, the ignition device temperature estimation unit estimates future temperature based on the current temperature, a plurality of current parameters, and the plurality of future parameters.

### Advantageous Effects of Invention

According to an aspect of the present invention, the ignition device can be prevented from being increased in size and cost while heat balance of the ignition device in the internal combustion engine is appropriately controlled.

Problems, configurations, and effects other than the above will be clarified by the following description of embodiments.

### BRIEF DESCRIPTION OF DRAWINGS

FIG. 1 is a general configuration diagram illustrating a basic configuration example of an internal combustion engine according to an embodiment.

FIG. 2 is a partially enlarged view illustrating an ignition plug according to an embodiment.

FIG. 3 is a functional block diagram illustrating a functional configuration of an internal combustion engine control device according to an embodiment.

FIG. 4 is a circuit diagram illustrating an example of an electric circuit including an ignition coil.

FIG. 5 is a diagram for illustrating a relationship among temperature of an electrode, minimum ignition energy, and an air-fuel ratio.

FIG. 6 is a conceptual diagram illustrating a relationship among suppliable discharge energy, required discharge energy, and a difference therebetween with respect to temperature of the ignition coil.

FIG. 7 is a conceptual diagram illustrating a relationship between temperature and discharge energy of a conventional ignition coil.

FIG. 8 is a conceptual diagram illustrating a relationship between temperature and discharge energy of an ignition coil when the present invention is applied.

FIG. 9 is a flowchart illustrating ignition, intake, and fuel injection control processing according to a first embodiment.

FIG. 10 is a flowchart illustrating the ignition, the intake, and the fuel injection control processing according to the first embodiment.

FIG. 11 is a conceptual diagram illustrating a weight and a bias of each neuron constituting a neural network model.

FIG. 12 is a diagram for illustrating a method for performing a calculation of each objective variable using a neural network model according to the first embodiment.

FIG. 13 is a conceptual diagram illustrating a neural network model used for the ignition and the fuel injection control processing according to the first embodiment.

FIG. 14 is a correspondence table illustrating a relationship between an objective variable and an explanatory variable when the neural network model according to the first embodiment is used.

FIG. 15 is a selection table of influence factors when an explanatory variable is selected to estimate ignition coil temperature according to the first embodiment.

FIG. 16 is a timing chart of movement speed, ignition device temperature, and ignition energy according to the first embodiment.

FIG. 17 is a timing chart of the movement speed, the ignition device temperature, and the ignition energy according to the first embodiment.

### DESCRIPTION OF EMBODIMENTS

### First Embodiment

Hereinafter, an internal combustion engine control device according to a first embodiment will be described. Parts common in the respective drawings are represented by the same reference numeral.

### Internal Combustion Engine Control Device

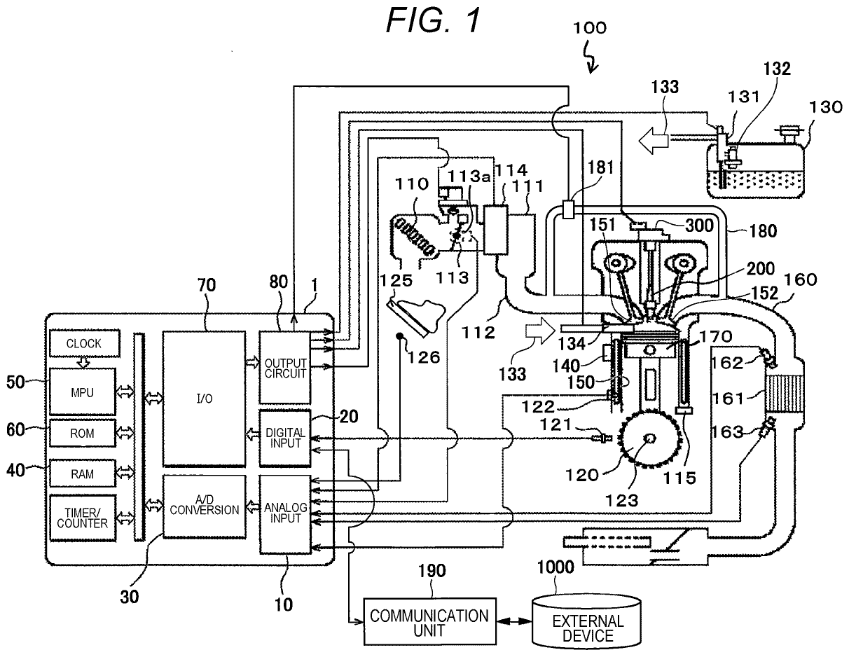

First, a configuration of an internal combustion engine control device according to an embodiment will be described. FIG. 1 is a general configuration diagram illustrating a basic configuration example of the internal combustion engine according to the first embodiment of the present invention.

Although FIG. 1 illustrates an internal combustion engine 100 that may include a single cylinder or a plurality of cylinders, the internal combustion engine 100 including four cylinders and mounted on a vehicle (mobile object) will be described as an example in the first embodiment.

As illustrated in FIG. 1, air (intake air) sucked into the internal combustion engine 100 from the outside flows through an air cleaner 110, an intake pipe 111, and an intake manifold 112. The air passing through the intake manifold 112 flows into each of cylinders 150 when an intake valve 151 is opened. The amount of air flowing into each cylinder 150 is adjusted by a throttle valve 113. The amount of air adjusted by the throttle valve 113 is measured by a flow rate sensor 114.

The throttle valve 113 is provided with a throttle opening sensor 113a that detects an opening of a throttle. Information on the opening of the throttle valve 113 detected by the throttle opening sensor 113a is output to a control device (electronic control unit: ECU) 1.

As the throttle valve 113, an electronic throttle valve driven by an electric motor is applied in the present embodiment. Alternatively, a throttle valve of another type may be applied as long as a flow rate of air can be appropriately adjusted, as a throttle valve according to the present invention.

Temperature of air flowing into each cylinder 150 is detected by an intake air temperature sensor 115.

A crank angle sensor 121 is provided radially outside a ring gear 120 attached to a crank shaft 123. The crank angle sensor 121 detects a rotation angle of the crank shaft 123. The crank angle sensor 121 detects the rotation angle of the crank shaft 123 every 10° and every combustion cycle in the present embodiment.

A water temperature sensor 122 is provided in a water jacket (not illustrated) of a cylinder head. The water temperature sensor 122 detects temperature of cooling water of the internal combustion engine 100.

A communication unit 190 is connected to a control device 1 to be able to communicate with each other. The communication unit 190 performs so-called CAN communication with the control device 1 through a known internal network system such as a controller area network (CAN) provided inside the vehicle. The communication unit 190 also relays the above-described CAN communication to a known external network through which so-called Ethernet communication is performed. Through the communication unit 190 described above, the control device 1 performs communication with one or more external devices 1000 provided on an internal network system of the vehicle or an external network. Examples of the external device 1000 include a known navigation device (not illustrated) provided inside the vehicle, a data center (not illustrated) provided on the external network and configured to collect and analyze information regarding movement states and movement environments of many vehicles including the own vehicle in a manner that can be used as a database. The control device 1 also receives external information from the external device 1000 through the communication unit 190. Examples of the external information include information on a destination of the own vehicle or travel route information (future position of the own vehicle) to the destination of the own vehicle obtained from the navigation device described above, and a parameter (e.g., road traffic information, outside temperature, and the like) for estimating future temperature that is temperature of an ignition device on a future travel route of the own vehicle obtained by an inquiry to the data center described above. The communication unit 190 transmits the received external information to the control device 1. The external device 1000, the communication unit 190, and the control device 1 constitute a control system for a mobile object. The navigation device described above performs inquiry processing to the data center described above in the present embodiment. Thus, the navigation device described above receives external information associated with the future travel route of the own vehicle from the data center, and transmits the received external information to the control device 1 through the communication unit 190.

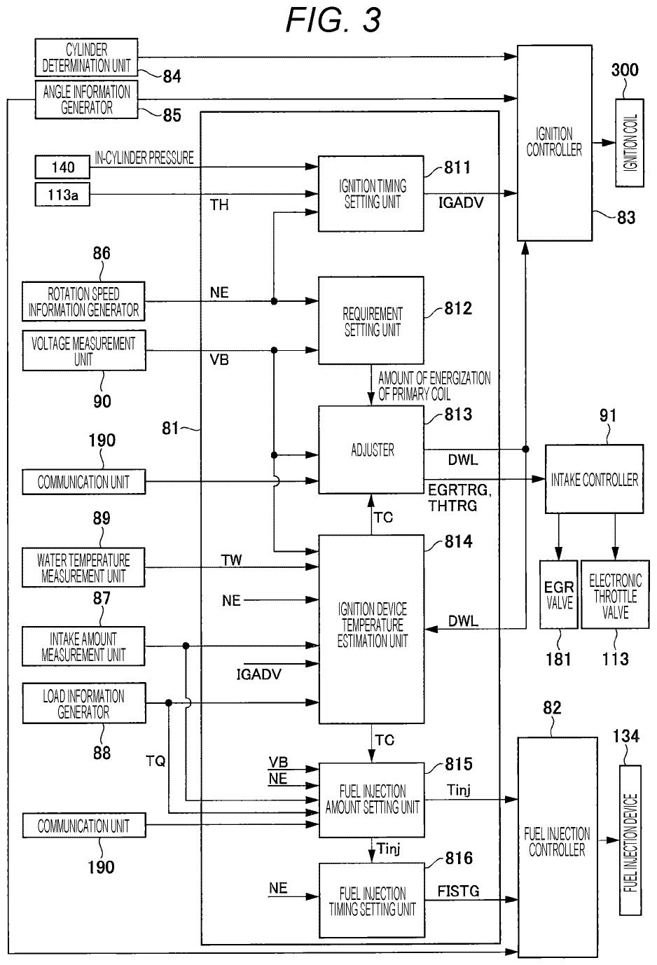

The vehicle is also provided with an accelerator position sensor 126 that detects a displacement (the amount of depression) of an accelerator pedal 125. The displacement of the accelerator position sensor 126 is output to the control device 1, and torque required by a driver is calculated by a load information generator 88 described later of the control device 1. The control device 1 controls the throttle valve 113 based on this required torque. A degree of opening of the throttle valve 113 is controlled by an intake controller 91 (see FIG. 3) described later of the internal combustion engine control device 1.

Fuel stored in a fuel tank 130 is sucked and pressurized by a fuel pump 131. The fuel sucked and pressurized by the fuel pump 131 is adjusted to predetermined pressure by a pressure regulator 132 provided together with the fuel pump 131 in the fuel tank 130. Then, the fuel adjusted to the predetermined pressure is supplied to a fuel injection device (injector) 134 through a fuel pipe 133 and injected into each cylinder 150. Excess fuel generated by the pressure adjustment of the pressure regulator 132 is discharged from the pressure regulator 132 to Control of the fuel injection device 134 is performed based on a fuel injection pulse (control signal) of a fuel injection controller 82 (see FIG. 3) described later of the control device 1.

A part (cylinder head) facing the combustion chamber of the internal combustion engine 100 is provided with a cylinder pressure sensor (referred to also as a combustion pressure sensor) 140. Examples of the cylinder pressure sensor 140 include a piezoelectric pressure sensor provided with a piezoelectric element that generates voltage in accordance with strain and a gauge pressure sensor provided with a diaphragm formed to be able to detect strain, each of which includes a pressure sensing unit provided facing the inside of the combustion chamber. This configuration enables detecting cylinder pressure (combustion pressure) that is a pressure value of air flowing into each cylinder 150.

An exhaust valve 152 and an exhaust manifold 160 are attached to each cylinder 150. When the exhaust valve 152 is opened, a gas after combustion, that is, an exhaust gas is discharged from the cylinder 150 to the exhaust manifold 160. The exhaust manifold 160 discharges the exhaust gas to the outside of the cylinder 150. The exhaust manifold 160 is provided on its exhaust side with a three-way catalyst 161. The three-way catalyst 161 purifies the exhaust gas. The exhaust gas purified by the three-way catalyst 161 is discharged to the atmosphere.

The exhaust manifold 160 and the intake manifold 112 communicate with each other using an EGR pipe 180. A part of the exhaust gas flowing through the exhaust manifold 160 is returned to the intake manifold 112 through the EGR pipe 180, and is diluted by the intake air in the intake manifold 112. That is, the internal combustion engine 100 includes exhaust gas recirculation (EGR) system. The amount of exhaust gas flowing through the EGR pipe 180 is adjusted by an EGR valve 181. For example, the control device 1 controls a degree of opening of the EGR valve 181 in accordance with a target air-fuel ratio, and adjusts the amount of exhaust gas (the amount of recirculation of exhaust gas) to be returned to the intake manifold 112. A degree of opening of the EGR valve 181 is controlled by an intake controller 91 (see FIG. 3) described later of the internal combustion engine control device 1.

An upstream air-fuel ratio sensor 162 is provided upstream of the three-way catalyst 161. The upstream air-fuel ratio sensor 162 outputs a signal corresponding to oxygen concentration related to an air-fuel ratio of the exhaust gas discharged from each cylinder 150. The upstream air-fuel ratio sensor 162 of the present embodiment is a so-called linear air-fuel ratio sensor that detects an air-fuel ratio (oxygen concentration) of exhaust gas discharged from each cylinder 150 as voltage that changes proportionally (linearly) to the air-fuel ratio.

A downstream air-fuel ratio sensor 163 is provided downstream of the three-way catalyst 161. The downstream air-fuel ratio sensor 163 outputs a signal corresponding to oxygen concentration related to an air-fuel ratio of exhaust gas purified by the three-way catalyst 161. The downstream air-fuel ratio sensor 163 of the present embodiment is a so-called O2 sensor that outputs a detection signal that changes in a binary manner in accordance with whether the air-fuel ratio is thicker (richer) or thinner (leaner) than a theoretical air-fuel ratio.

An ignition plug 200 is provided at a part facing a combustion chamber of each cylinder 150. The ignition plug 200 generates a spark by discharge (ignition), and the spark ignites the air-fuel mixture in the cylinder 150. Consequently, explosive combustion occurs in the cylinder 150 to push down a piston 170. When the piston 170 is pushed down, the crank shaft 123 is rotated. The ignition plug 200 is connected to an ignition coil 300 that generates (boosts) discharge voltage to be supplied to the ignition plug 200.

The control device 1 receives output signals from various sensors such as the throttle opening sensor 113a, the flow rate sensor 114, the crank angle sensor 121, the accelerator position sensor 126, the water temperature sensor 122, and the cylinder pressure sensor 140 described above. The control device 1 controls the amount of air passing through the throttle valve 113, the amount of exhaust gas passing through the EGR valve 181 and recirculating to an intake side, the amount of fuel injections of the fuel pump 131 and the fuel injection device 134, ignition timing of the ignition plug 200 using the ignition coil 300, and the like based on signals from these various sensors.

### Ignition Plug

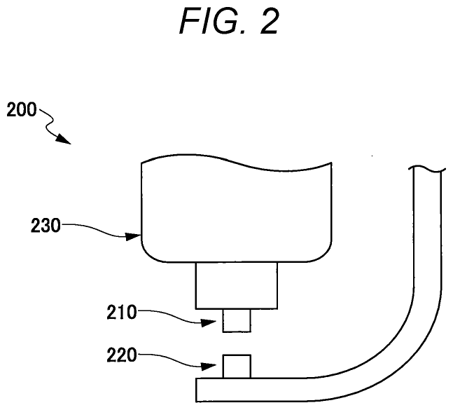

Next, the ignition plug 200 will be described with reference to FIG. 2.

FIG. 2 is a partially enlarged view illustrating the ignition plug 200.

As illustrated in FIG. 2, the ignition plug 200 includes a center electrode 210 and an outer electrode 220. The center electrode 210 is supported by a plug base (not illustrated) with an insulator 230 interposed therebetween. Consequently, the center electrode 210 is insulated. The outer electrode 220 is grounded.

When voltage is generated in the ignition coil 300 (see FIG. 1), a predetermined voltage (e.g., 20,000 V to 40,000 V) is applied to the center electrode 210. When the predetermined voltage is applied to the center electrode 210, discharge (ignition) occurs between the center electrode 210 and the outer electrode 220. Then, a spark generated by the discharge ignites an air-fuel mixture (gas component) of air and fuel in the cylinder 150.

Voltage at which discharge (ignition) occurs due to dielectric breakdown of the gas component in the cylinder 150 varies in accordance with a state of the gas (air-fuel mixture in the cylinder) existing between the center electrode 210 and the outer electrode 220 and cylinder pressure of the cylinder 150. The voltage at which this discharge occurs is referred to as a dielectric breakdown voltage.

Discharge control (ignition control) of the ignition plug 200 is performed by an ignition controller 83 described later (see FIG. 3) of the control device 1.

### Hardware Configuration of Control Device

Next, a general configuration of hardware of the control device 1 will be described.

As illustrated in FIG. 1, the control device 1 includes an analog input unit 10, a digital input unit 20, an analog/digital (A/D) converter 30, a random access memory (RAM) 40, a micro-processing unit (MPU) 50, a read only memory (ROM) 60, an input/output (I/O) port 70, and an output circuit 80.

The analog input unit 10 receives analog output signals from various sensors such as the throttle opening sensor 113a, the flow rate sensor 114, the accelerator position sensor 126, the upstream air-fuel ratio sensor 162, the downstream air-fuel ratio sensor 163, the cylinder pressure sensor 140, and the water temperature sensor 122.

The analog input unit 10 is connected to the A/D converter 30. The analog output signals received by the analog input unit 10 from the various sensors are subjected to signal processing such as noise removal, and then are converted into digital signals by the A/D converter 30. Then, the digital signals converted by the A/D converter 30 are stored in the RAM 40.

The digital input unit 20 receives a digital output signal from the crank angle sensor 121. The digital input unit 20 is connected to the I/O port 70. The digital output signal received by the digital input unit 20 is stored in the RAM 40 through the I/O port 70.

The digital input unit 20 is also configured to include a communication interface for performing communication (transmission and reception) with the external device 1000 using the communication unit 190, and receives a CAN communication signal of the internal network described above in this embodiment. The CAN communication signal received by the digital input unit 20 is stored in the RAM 40 through the I/O port 70. The external device 1000 is configured to include a known navigation device, for example. The navigation device performs matching processing between information items and predetermined road map data, the information items including: information on a current position of the vehicle obtained from a positioning signal of a so-called global positioning system (GPS), autonomous navigation position specifying processing, or the like; and information on a future position of the vehicle related to a preset destination of the vehicle. Then, the navigation device performs processing such as planned travel route search and route guidance of the vehicle to derive various types of additional information such as route information to the preset destination and road traffic information associated with the route information. The navigation device includes a travel history database (not illustrated). The travel history database is formed by sequentially registering (newly storing or overwriting and updating past information) a past travel state (the travel state can include average movement speed and information related to weather conditions such as intake air temperature and humidity) of the own vehicle as travel history information on the own vehicle, the travel history information being associated with a plurality of pieces of index information such as time and date (season) obtained from road map information and a clock (not illustrated). The travel history information registered in the travel history database is retrieved based on a future scheduled travel route of the own vehicle, a future scheduled travel date and time, and the like, and is not only converted into external information, but also transmitted to the control device 1.

Then, the control device 1 performs mutual communication with the external device 1000 (a navigation device in this embodiment) through the digital input unit 20 and the communication unit 190. For example, the control device 1 transmits a query message for requesting the external device for a parameter for estimating future temperature that is temperature of the ignition device on a future travel route. The external device having received the query message through the communication unit 190 reads past travel history information (such as average movement speed of the own vehicle) associated with route information to a current destination of the own vehicle from the travel history database, and transmits the read information to the control device 1. That is, the communication unit 190 relays communication for acquiring external information from the external device 1000 and outputting own vehicle information to the external device 1000.

Each signal stored in the RAM 40 is referred to or processed for calculation by the MPU 50.

The MPU 50 executes a control program (not illustrated) stored in the ROM 60 to process an output signal stored in the RAM 40 according to the control program. The MPU 50 calculates a control value according to the control program, the control value defining the amount of operation of each of actuators (such as the throttle valve 113, the EGR valve 181, the fuel injection device 134, the fuel pump 131, and the ignition coil 300) that drive the internal combustion engine 100, and temporarily stores the control value in the RAM 40.

The control value defining the amount of operation of each actuator stored in the RAM 40 is output to the output circuit 80 through the I/O port 70.

The output circuit 80 is electrically connected to a drive device of the throttle valve 113, the fuel pump 131, the fuel injection device 134, the EGR valve 181, and the ignition coil 300.

### Functional Block of Control Device

Next, a functional configuration of the control device 1 will be described with reference to FIG. 3.

FIG. 3 is a functional block diagram illustrating a functional configuration of the control device 1.

As illustrated in FIG. 3, the control device 1 is provided with the output circuit 80 described above. The output circuit 80 includes a general controller 81, the fuel injection controller 82, an ignition controller 83, and the intake controller 91 in the present embodiment. The intake controller 91 controls energization timing and energization time of the throttle valve 113 and the EGR valve 181. The control device 1 further includes a cylinder determination unit 84, an angle information generator 85, a rotation speed information generator 86, an intake amount measurement unit 87, a load information generator 88, a water temperature measurement unit 89, and a voltage measurement unit 90.

The angle information generator 85 measures a crank angle of the crank shaft 123 based on a digital output signal of the crank angle sensor 121. The cylinder determination unit 84 determines which stroke (e.g., expansion, compression, intake or compression stroke) of each cylinder 150 of the internal combustion engine 100 corresponds to a current crank angle measured by the angle information generator 85. The rotation speed information generator 86 measures engine rotation speed based on a digital output signal of the crank angle sensor 121.

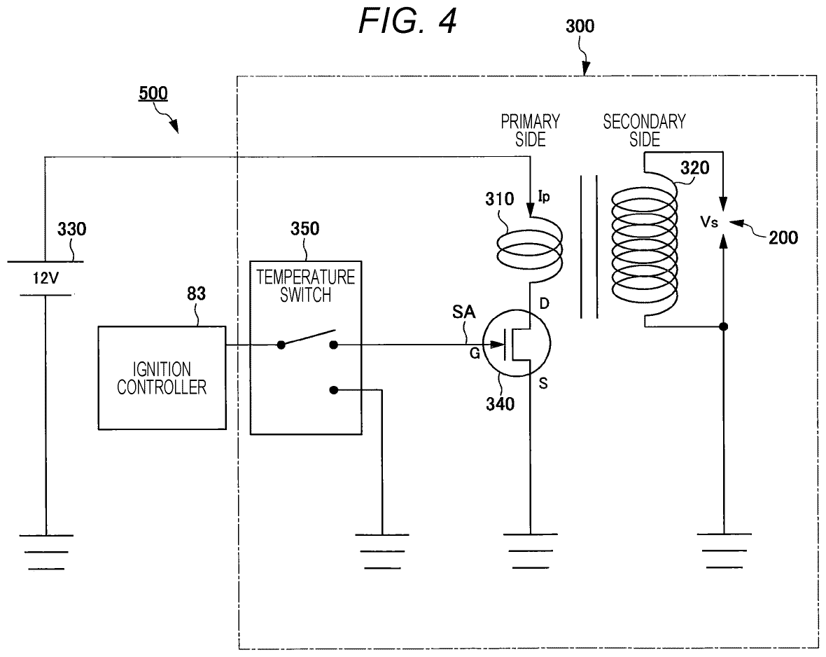

The intake amount measurement unit 87 measures the amount of intake air taken into the cylinder 150 based on an output signal of the flow rate sensor 114. The load information generator 88 calculates torque required by the driver based on an output signal of the accelerator position sensor 126. The water temperature measurement unit 89 measures temperature of engine cooling water. The voltage measurement unit 90 measures voltage of a DC power supply 330 (a battery of the internal combustion engine 100) illustrated in FIG. 4.

### General Controller

The general controller 81 includes an ignition timing setting unit 811, a requirement setting unit 812, an adjuster 813, an ignition device temperature estimation unit 814, a fuel injection amount setting unit 815, and a fuel injection timing setting unit 816.

The ignition timing setting unit 811 optimally calculates ignition timing IGADV, which is the amount of main operation of the internal combustion engine 100, based on an operation state of the internal combustion engine 100 obtained from outputs of various sensors, such as an output signal of the cylinder pressure sensor 140.

The requirement setting unit 812 calculates a required target air-fuel ratio, a required opening of the intake device, and required energization time (the amount of required energization) based on an operation state of the internal combustion engine 100 obtained from outputs of various sensors such as rotation speed NE and power supply voltage VB of the internal combustion engine 100. The required target air-fuel ratio is a value related to determination of the amount of fuel injection Tinj in the fuel injection amount setting unit 815. The required opening of the intake device includes an EGR required opening of the EGR valve 181 required during intake control and a required throttle opening of the throttle valve 113. The required energization time is time for energizing a primary coil 310 (see FIG. 4) of the ignition coil 300 required at the time of ignition.

The adjuster 813 calculates the energization time for energizing the primary coil 310 of the ignition coil 300 based on a current temperature value (referred to below as a current temperature TC) regarding the ignition device obtained from the ignition device temperature estimation unit 814, a temperature value (referred to below as a future temperature TCf) of the ignition device on the future path described above, and the required energization time (the amount of required energization) obtained from the requirement setting unit. The adjuster 813 also sets a control opening of the EGR valve 181 based on the current temperature TC, the future temperature TCf, and an EGR required opening obtained from the requirement setting unit. The adjuster 813 further sets a control opening of the throttle valve 113 based on the current temperature TC, the future temperature TCf, and the required throttle opening obtained from the requirement setting unit. Then, the adjuster 813 transmits a control instruction to the ignition controller 83 and the intake controller 91. The adjuster 813 corresponds to an adjuster according to the present invention.

The ignition device temperature estimation unit 814 calculates the current temperature TC using a neural network model having a preselected explanatory variable as an input. The ignition device temperature estimation unit 814 also estimates the future temperature TCf related to the ignition device as described later based on the external information acquired from the external device 1000 through the communication unit 190.

The fuel injection amount setting unit 815 optimally calculates the amount of fuel injection, which is the amount of main operation of the internal combustion engine 100, based on the external information acquired from the external device 1000 through the communication unit 190 and an operating state of the internal combustion engine 100 obtained from outputs of various sensors such as the rotation speed NE and the power supply voltage VB of the internal combustion engine 100. The fuel injection amount setting unit 815 transmits a control instruction to the fuel injection controller 82.

The fuel injection timing setting unit 816 optimally calculates opening/closing operation timing of a fuel injection valve in the fuel injection device 134 based on an operation state of the internal combustion engine 100 obtained from outputs of various sensors such as the rotation speed NE of the internal combustion engine 100 and the amount of fuel injection obtained from the fuel injection amount setting unit 815.

### Fuel Injection Controller

The fuel injection controller 82 controls energization timing and energization time of the fuel injection valve. The fuel injection controller 82 generates a fuel injection pulse based on fuel control information received from the general controller 81. The fuel injection controller 82 supplies the generated fuel injection pulse to the fuel injection controller 82. The fuel injection device 134 is driven in accordance with the fuel injection pulse.

Examples of the fuel control information include a value of the amount of fuel injection obtained from the fuel injection amount setting unit 815, a frequency of fuel injection performed for each one combustion cycle of the internal combustion engine 100, and the opening/closing operation timing of the fuel injection valve obtained from the fuel injection timing setting unit 816.

### Ignition Controller

The ignition controller 83 controls energization timing and energization time of the ignition coil 300. The ignition controller 83 calculates the energization start timing (energization start crank angle) of the primary coil 310 based on ignition control information received from the general controller 81. The energization start timing of the primary coil 310 is obtained by subtracting the energization time in time series from ignition timing of interrupting the current flowing to the primary coil 310.

Examples of the ignition control information include engine rotation speed information, a value of ignition timing (a crank angle from spark generation timing to a compression top dead center of the internal combustion engine), a value of energization time obtained from the adjuster 813.

The ignition controller 83 starts energizing the primary coil 310 based on the energization start timing calculated above, and outputs an ignition signal SA (see FIG. 4) for interrupting power to the primary coil 310 based on the ignition timing. Consequently, ignition of the air-fuel mixture using the ignition plug 200 is performed.

### Electric Circuit Including Ignition Coil

Next, an electric circuit including an ignition coil will be described with reference to FIG. 4.

FIG. 4 is a diagram illustrating the electric circuit including the ignition coil.

The electric circuit 500 illustrated in FIG. 4 includes the ignition coil 300. The ignition coil 300 includes the primary coil 310 wound with a predetermined number of windings and a secondary coil 320 wound with a larger number of windings than the primary coil 310.

The primary coil 310 is connected at one end to the DC power supply 330. Consequently, a predetermined voltage (e.g., 12 V) is applied to the primary coil 310. The primary coil 310 is connected at the other end to a drain (D) terminal of an igniter (energization control circuit) 340 and is grounded through an igniter 340. As the igniter 340, a transistor, a field effect transistor (FET), or the like is used.

The igniter 340 includes a gate (G) terminal that is connected to the ignition controller 83 through a temperature switch unit 350 having a temperature sensing part. The temperature switch unit 350 is installed to prevent damage due to overheating of the ignition coil 300. The temperature switch unit 350 interrupts the ignition signal SA output from the ignition controller 83 to the igniter 340 when temperature of the ignition coil 300 becomes equal to or higher than a value predetermined in the temperature sensing part.

When the temperature switch unit 350 interrupts the ignition signal SA, energization to the primary coil 310 is stopped. Thus, overheating of the igniter 340 can be avoided. When the temperature of the ignition coil 300 becomes less than the value predetermined in the temperature sensing part, the ignition signal SA output from the ignition controller 83 is input to the gate (G) terminal of the igniter 340.

When the gate (G) terminal of the igniter 340 receives the ignition signal SA, the igniter 340 is energized between the drain (D) terminal and a source(S) terminal, and thus a current flows between the drain (D) terminal and the source(S) terminal. As a result, a current flows through the primary coil 310, and power (electric energy) is accumulated.

When output of the ignition signal SA from the ignition controller 83 is stopped, the current flowing through the primary coil 310 is interrupted. As a result, the secondary coil 320 generates a high voltage corresponding to a winding number ratio of the coil to the primary coil 310.

The high voltage generated in the secondary coil 320 is applied to the center electrode 210 (see FIG. 2) of the ignition plug 200. Consequently, a potential difference is generated between the center electrode 210 of the ignition plug 200 and the outer electrode 220. When the potential difference generated between the center electrode 210 and the outer electrode 220 becomes equal to or larger than a dielectric breakdown voltage Vm of ambient gas (air-fuel mixture in the cylinder 150), a gas component undergoes dielectric breakdown to cause discharge between the center electrode 210 and the outer electrode 220. As a result, fuel (air-fuel mixture) is ignited. The ignition plug 200 and the electric circuit 500 including the ignition coil 300 correspond to an ignition device according to the present invention.

A discharge path generated between the center electrode 210 and the outer electrode 220 has a high temperature of several thousand degrees C. The discharge path is in contact with the ambient gas and the electrodes 210 and 220, so that the heat generation energy of the discharge is distributed to the ambient gas and the electrodes 210 and 220. Then, the heat generation energy distributed to the ambient gas heats (preheats) the ambient gas and the electrodes 210 and 220 to promote ignition.

### Temperature of Electrode, Minimum Ignition Energy, and Air-Fuel Ratio

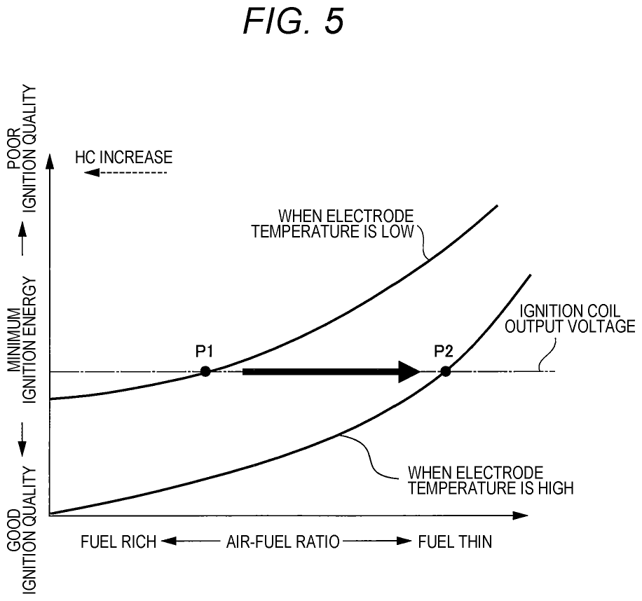

Next, a relationship among temperature of an electrode of the ignition plug 200, minimum ignition energy, and an air-fuel ratio will be described with reference to FIG. 5.

FIG. 5 is a diagram for illustrating the relationship among temperature of an electrode, minimum ignition energy, and an air-fuel ratio.

FIG. 5 shows values of air-fuel ratios corresponding to values of minimum ignition energy. FIG. 5 indicates voltage scale values corresponding to the minimum ignition energy of the air-fuel mixture in a vertical direction, and air-fuel ratio scale values corresponding to air-fuel ratios of the air-fuel mixture in a horizontal direction. FIG. 5 shows an air-fuel ratio P1 that is a value of an air-fuel ratio corresponding to a predetermined value of the minimum ignition energy that can ignite the air-fuel mixture in a state where the electrode temperature of the ignition plug is low (e.g., minus 25° C.). In contrast, an air-fuel ratio P2 is a value of an air-fuel ratio corresponding to a predetermined value of the minimum ignition energy that can ignite the air-fuel mixture in a state where the electrode temperature of the ignition plug is high (e.g., minus 7° C.).

As illustrated in FIG. 5, as the air-fuel ratio increases (the fuel becomes thinner), the value of the minimum ignition energy of the air-fuel mixture increases in the internal combustion engine 100, so that the air-fuel mixture is less likely to be ignited by discharge (ignition) from the ignition plug. Then, the value of the minimum ignition energy of the air-fuel mixture increases as electrode temperature of the ignition plug decreases, so that the air-fuel mixture is less likely to be ignited by discharge (ignition) from the ignition plug.

For example, it is assumed that a value equivalent to the minimum ignition energy corresponding to the air-fuel ratio P2 with the ignition plug having high electrode temperature is obtained when the ignition plug has a low electrode temperature. In this assumption, the discharge (ignition) from the ignition plug 200 cannot exceed the minimum ignition energy unless the air-fuel ratio is set to the air-fuel ratio P1 having a smaller value (fuel is thick) than the air-fuel ratio P2. Thus, the rich air-fuel ratio (P1) on the premise that the electrode of the ignition plug 200 always has a low temperature has been conventionally set in the fuel injection controller 82, as a setting having a safety margin that does not cause inconvenience such as misfire in the internal combustion engine 100. As a result, the internal combustion engine 100 generates more hydrocarbons (HC) during combustion as a ratio of fuel in the air-fuel mixture increases.

In contrast, the minimum ignition energy for igniting the air-fuel mixture decreases as temperature of the electrode of the ignition plug 200 at cold start (see the thick arrow in FIG. 5) is increased. Thus, even when the air-fuel ratio is increased (the fuel is thinned), discharge (ignition) from the ignition plug exceeds the minimum ignition energy to enable ignition of the air-fuel mixture. As a result, generation of hydrocarbons (HC) in the internal combustion engine 100 can be reduced. Thus, the internal combustion engine 100 is configured to increase temperature of the electrode of the ignition plug 200 at cold start before discharge (ignition) as described later. This configuration enables increasing the air-fuel ratio at cold start and suppressing the generation of hydrocarbons (HC).

### Temperature and Discharge Energy of Ignition Coil

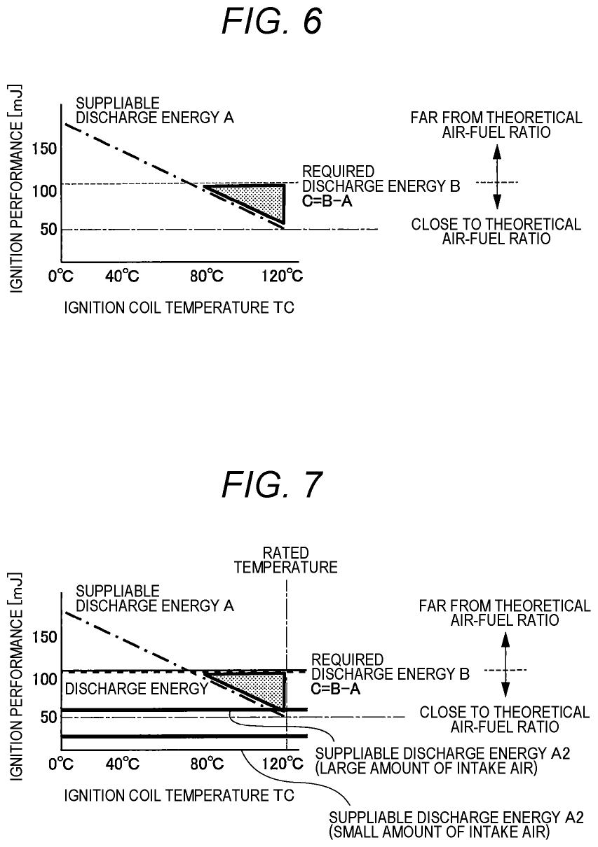

Next, temperature and discharge energy of the ignition coil 300 will be described with reference to FIG. 6.

FIG. 6 is a conceptual diagram illustrating a relationship among suppliable discharge energy, required discharge energy, and a difference therebetween with respect to temperature of the ignition coil.

FIG. 6 illustrates a graph with a horizontal axis representing a temperature value TC (referred to below as an “ignition coil temperature TC”) related to an actual ignition device of the ignition coil 300 (see FIG. 4), and a vertical axis representing ignition performance indicated by discharge energy in units of megajoule (mJ). The ignition performance is based on the above-described minimum ignition energy required to ignite the air-fuel mixture, and includes required discharge energy set in accordance with an operation state of the internal combustion engine 100, and the suppliable discharge energy serving as an upper limit value for allowing the ignition coil temperature TC to be equal to or lower than a rated temperature, for example. As described above, the required discharge energy is affected by the air-fuel ratio of the air-fuel mixture, the amount of recirculation of exhaust gas, and the like. The suppliable discharge energy tends to increase as the ignition coil temperature TC deviates from the rated temperature. When the rated temperature is set to 120° C. in FIG. 6, for example, and the ignition coil temperature TC decreases to 80° C. and 40° C. lower than the rated temperature, a value of the suppliable discharge energy increases in accordance with the decrease in temperature.

The ignition coil 300 includes the primary coil 310 and the igniter 340 through each of which a high current of about 15 A, for example, flows, so that instantaneous heat generation is repeated every time ignition is performed. Thus, suppliable discharge energy A is set based on the ignition coil temperature TC to control energization of the ignition coil 300 based on the suppliable discharge energy A, thereby preventing temperature of the primary coil 310 of the ignition coil 300 and the igniter 340 from exceeding the preset rated temperature (designed heat resistant temperature of each component). The discharge energy A, which can be supplied by the ignition coil 300, decreases as the ignition coil temperature TC increases to approach the rated temperature.

Required discharge energy B is mainly affected by a state of the air-fuel mixture near an ignition plug electrode, that is, by an air-fuel ratio and an intake flow. The required discharge energy B has a substantially minimum value when the air-fuel ratio of the air-fuel mixture is close to the theoretical air-fuel ratio. In contrast, the required discharge energy B increases as the air-fuel ratio deviates from the theoretical air-fuel ratio.

In general, the suppliable discharge energy A and the required discharge energy B each have a different inclination with respect to a temperature axis of the ignition coil temperature TC indicated in the horizontal direction in FIG. 6. Thus, the suppliable discharge energy A and the required discharge energy B cross each other as illustrated in FIG. 6. At this time, when temperature at a point where the two types A and B of discharge energy cross each other is higher than the rated temperature (a use temperature range in the design) of the ignition coil 300, for example, the discharge energy A equal to or higher than the required discharge energy B can be always output from the ignition coil 300 without exceeding the rated temperature. Then, the ignition performance of the internal combustion engine 100 is always satisfied without being restricted by the temperature of the ignition coil 300.

In contrast, when a lean combustion or dilution combustion technique in which an air-fuel mixture having an air-fuel ratio larger than the theoretical air-fuel ratio (fuel is thin) is combusted to operate the internal combustion engine is implemented to improve fuel efficiency of the vehicle, for example, the required discharge energy B increases as the air-fuel ratio of the air-fuel mixture deviates from the theoretical air-fuel ratio. Thus, temperature at a point where the two types A and B of discharge energy cross each other may fall below the rated temperature of the ignition coil 300 (within the use temperature range). Then, the required discharge energy B exceeding the suppliable discharge energy A is less likely to be continuously supplied to the ignition coil 300 on a higher temperature side than the temperature at the cross point. For this reason, practicability of a so-called fuel efficiency improvement technique such as lean combustion or dilution combustion of the internal combustion engine 100 is restricted by the shortage of the suppliable discharge energy A on the higher temperature side than the temperature of the point where two types of the discharge energy A and the discharge energy B cross each other.

Hereinafter, a difference value between the suppliable discharge energy A and the required discharge energy B when the suppliable discharge energy A is lower than the required discharge energy B is defined as an ignition performance insufficiency C.

### Relationship Between Temperature and Discharge Energy of Conventional Ignition Coil

Next, a relationship between temperature and discharge energy of a conventional ignition coil will be described with reference to FIG. 7.

FIG. 7 is a conceptual diagram illustrating the relationship between temperature and discharge energy of the conventional ignition coil.

FIG. 7 illustrates a graph with a horizontal axis representing the ignition coil temperature TC, and a vertical axis representing ignition performance. FIG. 7 illustrates a thick line that indicates discharge energy output from the conventional ignition coil. As illustrated in FIG. 7, a conventional (e.g., see JP 2000-054941 A) ignition device has a value of the ignition coil temperature TC, the value being unclear. Thus, when the rated temperature is set to 120° C. in FIG. 7, for example, suppliable discharge energy A2 at 120° C. is always applied as an output limit value of the discharge energy output by the ignition coil. That is, the conventional ignition device generates the suppliable discharge energy A2 that is substantially unchanged with respect to change in the ignition coil temperature TC. In other words, the conventional ignition device is designed so that temperature at the point where the suppliable discharge energy A2 and the required discharge energy B cross each other is higher than the rated temperature of the ignition coil when ignition is performed with an air-fuel ratio close to a theoretical air-fuel ratio. Thus, the ignition performance of the internal combustion engine 100 to which the conventional ignition device is applied is always satisfied without being restricted by the temperature of the ignition coil 300 at least under conditions where ignition is performed with an air-fuel ratio close to the theoretical air-fuel ratio.

However, when lean combustion or exhaust gas recirculation is performed in which a part of an exhaust gas after combustion is taken for another intake, the required discharge energy B increases from that when the air-fuel mixture with an air-fuel ratio close to the theoretical air-fuel ratio is ignited as described above. Thus, temperature at a point where the two types A and B of discharge energy cross each other is lower than the rated temperature. This state increases the ignition performance insufficiency C in accordance with increase in the ignition coil temperature TC on a side at a temperature higher than the temperature at the point where the suppliable discharge energy A and the required discharge energy B cross each other, and thus a misfire may occur. Under such circumstances, an internal combustion engine using the conventional ignition device is restricted to the lean combustion and the exhaust gas recirculation that are performed only under a low load situation in which the amount of air flowing into a cylinder is reduced to reduce the required discharge energy B.

### Relationship Between Temperature and Discharge Energy of Ignition Coil According to Present Invention

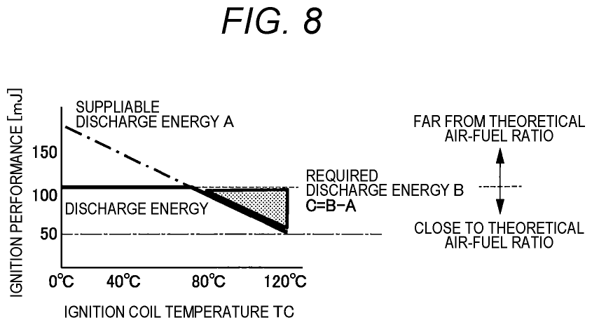

Next, a relationship between temperature and discharge energy of an ignition coil according to the present invention will be described with reference to FIG. 8.

FIG. 8 is a conceptual diagram illustrating the relationship between temperature and discharge energy of the ignition coil when the present invention is applied.

FIG. 8 illustrates a graph with a horizontal axis representing the ignition coil temperature TC, and a vertical axis representing ignition performance. FIG. 8 illustrates a thick line that indicates discharge energy output from the ignition coil 300. As illustrated in FIG. 8, the present embodiment shows that when the temperature of the ignition coil 300 becomes higher than temperature at a point where the suppliable discharge energy A and the required discharge energy B cross each other, the suppliable discharge energy A is prioritized over the required discharge energy B.

That is, the present embodiment sets the discharge energy of the ignition coil 300 to the suppliable discharge energy A when the ignition coil temperature TC becomes higher than the temperature at the point where the suppliable discharge energy A and the required discharge energy B cross each other. Consequently, when the ignition coil temperature TC becomes higher than the temperature at the point where the suppliable discharge energy A and the required discharge energy B cross each other, the discharge energy of the ignition coil 300 is gradually reduced as the ignition coil temperature TC rises.

The present embodiment also enables a value of the required discharge energy B to be substantially lowered by increasing the amount of fuel injection to perform ignition with an air-fuel ratio close to the theoretical air-fuel ratio on a side at a temperature higher than the temperature at the point where the suppliable discharge energy A and the required discharge energy B cross each other. That is, the present embodiment compensates for insufficient ignition performance due to reduction in the discharge energy by enhancing ignition quality of the air-fuel mixture. Consequently, required ignition performance can be satisfied while the ignition coil 300 is prevented from overheating by lowering the value of the required discharge energy B. As a result, a misfire can be suppressed. The present embodiment enables increasing a value of the required discharge energy B to higher than that of the conventional ignition device to perform lean combustion and exhaust gas recirculation on a side at a temperature lower than the temperature of the point where the suppliable discharge energy A and the required discharge energy B cross each other. Consequently, even under a high load situation where the required discharge energy B is maximized due to increase in the amount of air flowing into the cylinder or the like, the lean combustion and the exhaust recirculation can be performed more frequently than the conventional ignition device while a misfire and overheat of the ignition coil 300 are mutually prevented. As a result, fuel efficiency of the vehicle can be improved.

As described above, the discharge energy of the ignition coil 300 is changed in accordance with temperature of the ignition coil 300 in the present embodiment. Thus, the temperature of the ignition coil 300 (temperature of the ignition device) needs to be grasped. The temperature of the ignition coil 300 can be detected by providing a temperature sensor, for example.

However, providing the temperature sensor in the ignition coil 300 may cause increase in cost along with increase in number of detection elements and wires, or increase in size of a housing. Thus, the temperature of the ignition coil 300 is estimated without providing the temperature sensor in the present embodiment. Consequently, increase in cost and increase in size of the housing can be suppressed while a misfire is prevented.

### Ignition, Intake, and Fuel Injection Control Processing

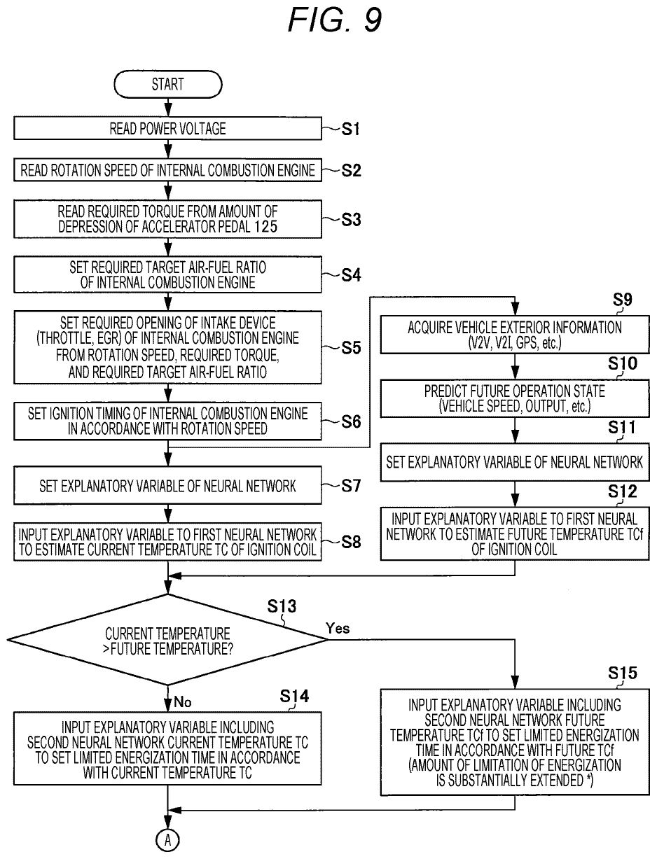

Ignition, intake, and fuel injection control processing according to the first embodiment will be described with reference to FIGS. 9, 10, and 13.

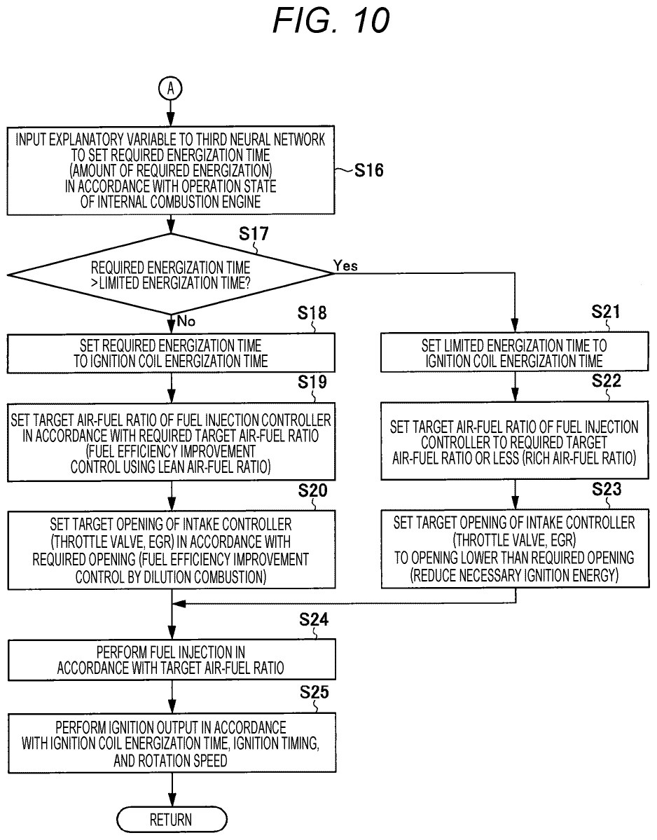

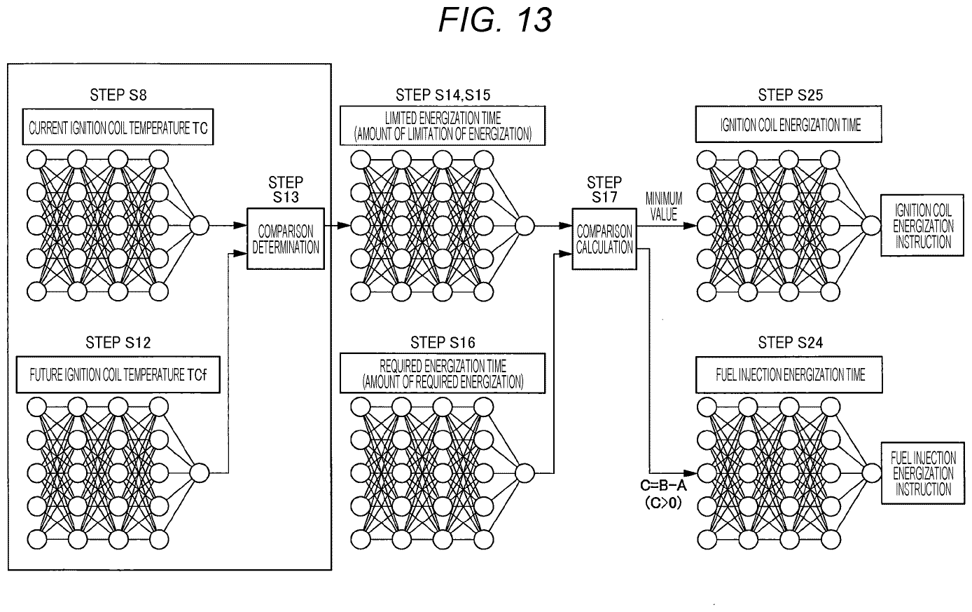

FIGS. 9 and 10 are each a flowchart illustrating the ignition, the intake, and the fuel injection control processing according to the first embodiment. FIG. 13 is a conceptual diagram illustrating an input/output relationship between an explanatory variable and an objective variable among a plurality of neural network models used for the ignition and the fuel injection control processing according to the first embodiment.

The ignition, the intake, and the fuel injection control processing according to the first embodiment are started together with a start of the internal combustion engine 100 (engine start). First, the general controller 81 acquires current power supply voltage VB (S1). Subsequently, the general controller 81 acquires current rotation speed NE of the internal combustion engine 100 (S2). Next, the load information generator 87 of the general controller 81 obtains required torque TQ obtained from the amount of depression of the accelerator pedal 125 (S3). Then, the requirement setting unit 812 of the general controller 81 sets a required target air-fuel ratio of the internal combustion engine 100, which corresponds to the required torque TQ (S4). Subsequently, the requirement setting unit 812 of the general controller 81 sets the required EGR opening and the required throttle opening of the EGR valve 181, which are each a target opening of the intake device (S5). Additionally, the ignition timing setting unit 811 of the general controller 81 sets ignition timing of the internal combustion engine 100 in accordance with the current rotation speed NE (S6).

Next, the general controller 81 sets an explanatory variable of a first neural network model having the ignition coil temperature TC as an objective variable (S7). In step S7, information regarding a current state of the vehicle is set as an explanatory variable in the first neural network model having the ignition coil temperature TC as the objective variable to estimate the current temperature TC of the ignition device. The information regarding the current state of the vehicle includes the current amount of intake air based on an output signal of the flow rate sensor 114, the current power supply voltage VB, the current rotation speed NE, and the current movement speed of the vehicle.

Next, the ignition device temperature estimation unit 814 of the general controller 81 inputs the explanatory variable set in step S4 to the first neural network model having the ignition coil temperature TC as the objective variable, and estimates the current temperature TC (S8).

Meanwhile, the general controller 81 obtains external information through the communication unit 190 (S9) in parallel with the processing in steps S7 to S8. At this time, the ignition device temperature estimation unit 814 transmits a query message for making an inquiry to the above-described navigation device through the communication unit 190. Then, external information obtained from the navigation device as a response is returned to the ignition device temperature estimation unit 814 through the communication unit 190. The external information relates to a state of the own vehicle on a future path, and corresponds to a prediction parameter according to the present invention. Examples of the external information include average movement speed based on road traffic information, outside temperature information on a future path of the own vehicle, and past driving history information on the own vehicle. Alternatively, the external information may be obtained as past driving history information on an unspecified number of vehicles obtained by so-called vehicle-to-infrastructure (V2I) communication between the navigation device and the above-described data center, and as movement speed of another vehicle obtained through vehicle-to-vehicle (V2V) communication that can be performed with another vehicle ahead on a future path of the own vehicle. Then, the external device (the navigation device in this embodiment) obtains a future position of the own vehicle on the scheduled moving path to a destination of the own vehicle on a map and a prediction parameter corresponding to the future position of the own vehicle based on information such as a current time, a current position (current location) of the own vehicle on the map, preset destination information for the own vehicle, and current movement speed of the own vehicle, for example.

Next, the general controller 81 predicts information regarding a future state of the vehicle based on the external information (S10). The information regarding the future state of the vehicle includes at least future power supply voltage VB, future movement speed of the vehicle, and future rotation speed NE. The future power supply voltage VB can be substituted by a value of the current power supply voltage VB. The future rotation speed NE can be calculated based on future movement speed of the vehicle and a predetermined drive device reduction ratio of the own vehicle, or can be substituted by a value of the current rotation speed NE. This prediction can also be performed under so-called stand-alone control without using vehicle exterior information. This prediction also enables a driving state of the own vehicle on a future path to be predicted based on time, a travel distance, and the like obtained from an internal database that is formed in the control device 1 instead of the external device to collect and register information related to a movement state and movement environment of the own vehicle, the information constituting past driving history information on the own vehicle. For example, a vehicle used for commuting or delivery is expected to perform repeated operation with punctuality between two predetermined points of arrival and departure points, so that a driving state of the own vehicle on a subsequent path can be easily predicted.

Next, the general controller 81 sets the above-described information regarding the future state of the vehicle as an explanatory variable of the first neural network model having the ignition coil temperature TC as the objective variable (S11).

Subsequently, the ignition device temperature estimation unit 814 of the general controller 81 inputs the explanatory variable set in step S11 to the first neural network model having the ignition coil temperature TC as the objective variable to estimate the future temperature TCf on a future movement path (S12). The future temperature TCf may be a temperature of the ignition device after elapse of a predetermined time (e.g., 1 minute), for example. The current temperature TC in the first neural network model in steps S7 to S8 and the future temperature TCf in the first neural network model in steps S9 to S12 can be output by synchronizing an operation interval and an operation frequency in a time series of processing, or can be output asynchronously by varying the operation interval and the operation frequency in the time series of the processing. For example, the future temperature TCf in step S12 is output at a lower frequency than the current temperature TC in step S8 in the present embodiment. When the future temperature TCf is output at a low frequency in the time series as described above, a frequency of communication with the external device for obtaining an explanatory variable having a causal relationship with the future temperature TCf can be reduced to adjust a communication load of the internal network and the external network.

Next, the adjuster 813 of the general controller 81 determines whether the current temperature TC is higher than the future temperature TCf (S13). When it is determined in step S13 that the current temperature TC is equal to or lower than the future temperature TCf, the adjuster 813 inputs the current temperature TC to an explanatory variable of a second neural network model having limited energization time (the amount of limitation of energization) as an objective variable, the limited energization time being an energization time value of the ignition coil 300, the energization time value corresponding to the above-described suppliable discharge energy A, thereby setting the limited energization time in accordance with the current temperature TC (S14). Predetermined explanatory variables to be input to the second neural network model in step S14 include at least the current power supply voltage VB, the current rotation speed NE, and the current temperature TC.

When it is determined in step S13 that the current temperature TC is larger than the future temperature TCf, the adjuster 813 inputs the future temperature TCf to the explanatory variable of the above-described second neural network model having the limited energization time as the objective variable, thereby setting the limited energization time in accordance with the future temperature TCf (S15). That is, when the future temperature TCf of the ignition device is estimated to be lower than the current temperature TC on the future movement path, control is performed to enable large required discharge energy B(see FIGS. 6 and 7 to 8) for lean combustion or dilution and lean combustion to be supplied to the ignition device by setting the limited energization time, that is, the suppliable discharge energy A in accordance with the future temperature TCf. This control enables the adjuster 813 to improve fuel efficiency of the internal combustion engine by performing lean combustion for increasing a target air-fuel ratio (diluting fuel in intake air to have an air-fuel ratio thinner than the theoretical air-fuel ratio) and dilution combustion for increasing the amount of exhaust gas recirculation for recirculating exhaust gas to the intake manifold 112 through the EGR valve 181. A degree of the lean combustion or the dilution combustion can be adjusted in accordance with an operation state by adjusting the fuel injection valve to change the amount of fuel injection into intake air, adjusting opening of the EGR valve to change the amount exhaust gas recirculation, or adjusting opening of the throttle valve to change the amount of intake.

After the processing in step S14 or step S15, the requirement setting unit 812 of the general controller 81 inputs an explanatory variable to a third neural network model having required energization time as an objective variable, and outputs the required energization time in accordance with an operation state of the internal combustion engine 100 (S16). Explanatory variables to be input to the third neural network model include at least the current power supply voltage VB, the current rotation speed NE, and a current intake flow rate (the amount of intake). The explanatory variables to be input to the third neural network model also include a value of a required target air-fuel ratio corresponding to the degree of the lean combustion or the dilution combustion described above, and being in accordance with an operation state of the internal combustion engine 100, and a required opening value of opening of the EGR valve in accordance with the operation state of the internal combustion engine 100.

Next, the adjuster 813 of the general controller 81 determines whether the required energization time acquired in step S16 is longer than the limited energization time acquired in step S14 or step S15 (S17). When it is determined in step S17 that the required energization time is not longer than the limited energization time (NO in S17), the adjuster 813 sets the required energization time as the energization time of the ignition coil 300 (referred to below as “ignition coil energization time”) (S18).

After the processing in step S18, the fuel injection amount setting unit 815 of the general controller 81 sets the value of the required target air-fuel ratio in accordance with the operation state of the internal combustion engine 100 described above as a target air-fuel ratio of the fuel injection controller 82 (S19). Then, the intake controller 91 sets a value of the required opening of the EGR valve 181 in accordance with the above-described operating state of the internal combustion engine 100 as a target opening of the EGR valve 181 (S20). Consequently, fuel efficiency can be improved by performing the lean combustion or the dilution combustion in accordance with the operating state of the internal combustion engine 100.

In contrast, when it is determined in step S17 that the required energization time is larger than the limited energization time (YES in S17), the adjuster 813 sets the limited energization time as the ignition coil energization time (S21).

After the processing in step S20, the fuel injection amount setting unit 815 of the general controller 81 corrects the value of the required target air-fuel ratio in accordance with the operation state of the internal combustion engine 100 to the theoretical air-fuel ratio at which the required discharge energy B has a minimum value or a value close to the theoretical air-fuel ratio, and then sets the corrected value of the required target air-fuel ratio as the target air-fuel ratio of the fuel injection controller 82 (S22). Then, the intake controller 91 corrects the required opening of the EGR valve 181 in accordance with the operation state of the internal combustion engine 100 described above to a value smaller than the required opening, and then sets the corrected value as the target opening of the EGR valve 181 (S23). Consequently, the value of the minimum ignition energy of the air-fuel mixture can be reduced (the required discharge energy B can be reduced) to prevent a misfire.

Next, the fuel injection controller 82 causes the fuel injection device 134 to inject fuel (S24). Specifically, the fuel injection controller 82 energizes the fuel injection device 134 with a drive current (drive voltage) in accordance with the amount of fuel injection Tinj that is based on the target air-fuel ratio and is set in step S19 or step S22, and fuel injection timing FISTG set by the fuel injection timing setting unit 816. As illustrated in FIG. 13, fuel injection energization instruction information items such as the amount of fuel injection Tinj and the fuel injection timing FISTG can be set by inputting explanatory variables to a fourth neural network model using the information items as objective variables.

Next, the ignition controller 83 causes the ignition device to perform ignition (S25). Specifically, the ignition controller 83 outputs the ignition signal SA in accordance with the ignition coil energization time set in steps S18 and S21, the ignition timing IGADV set in step S3, and the rotation speed NE to the ignition coil 300. After the processing of step S25, the general controller 81 returns the processing to step S1. As illustrated in FIG. 13, the ignition coil energization instruction information such as the ignition timing IGADV can be set by inputting an explanatory variable to a fifth neural network model using the ignition coil energization instruction information as an objective variable.

### Neural Network Model

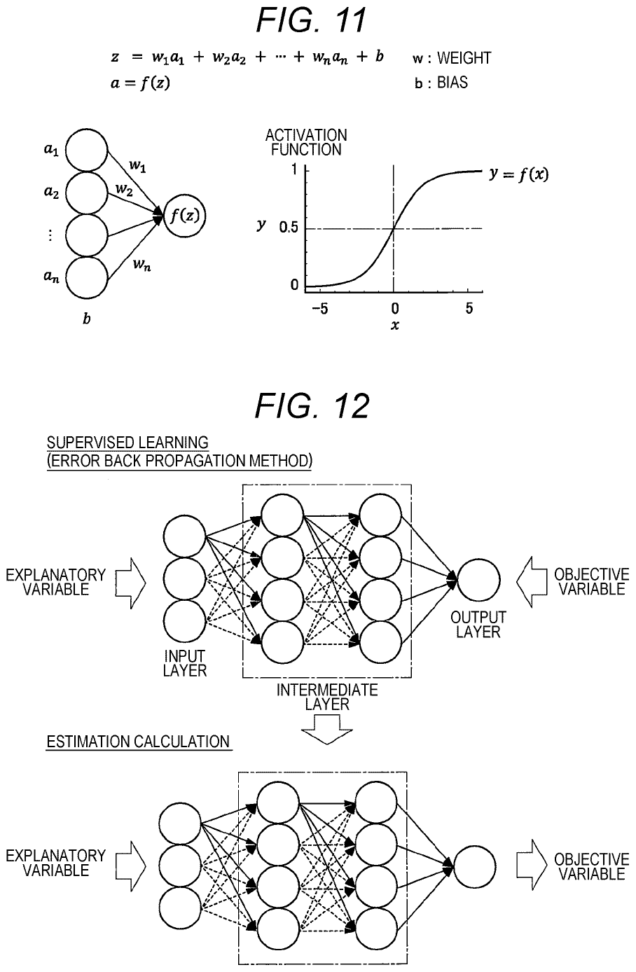

Next, a neural network model according to the present embodiment will be described with reference to FIGS. 11 and 12. FIG. 11 is a conceptual diagram illustrating a weight and a bias of each neuron constituting each of neural network models such as the first neural network model having the ignition coil temperature TC as the objective variable, the second neural network model having the limited energization time as the objective variable, and the third neural network model having the required energization time as the objective variable. FIG. 12 is a diagram for illustrating a method for performing a calculation of each objective variable using a neural network model according to the present embodiment. FIG. 13 is a conceptual diagram illustrating a neural network model used for the ignition and the fuel injection control processing according to the first embodiment.

The neural network model is a mathematical model that simulates a mechanism of a human cranial nerve circuit. In the present embodiment, the neural network model is constituted by a multilayer neural network model provided with an input layer to which an explanatory variable is input, an output layer that outputs an objective variable, and an intermediate layer that connects the input layer and the output layer. The neural network model is often used as a means for performing deep learning in so-called machine learning. For example, an error back propagation method can be applied to an algorithm of the machine learning. Although the neural network model is used in the present embodiment, the present invention is not limited to this example as long as machine learning enables estimation of the ignition coil temperature TC and determination of the limited energization time and the required energization time.

As illustrated in FIG. 11, a weight w and a bias b are set to each neuron (unit) constituting the neural network model. Inputs al to an are input to respective n neurons, and are respectively multiplied by weights w1 to wn set for the respective neurons. Then, the inputs al to an multiplied by the weights w1 to wn, respectively, are added (combined) in neurons of the next layer, and an output z is obtained in which the bias b is added to a result of the addition. The neurons of the next layer output “a” represented by a function f(z).

Additionally, a function called an activation function is defined for each neuron. For the activation function, a logistic function (sigmoid function), a ramp function (rectified linear unit (ReLU) function), and the like are appropriately set. FIG. 12 illustrates an example in which as an input x increases from 0, the neuron is more activated to cause an output y (=f(x) ) to be closer to 1, and as the input x decreases from 0, the neuron is more deactivated to cause the output y to be closer to 0. For example, when the input x is “5”, the output y of the activation function is “1”, and the neuron outputs “1” to a neuron in the next layer.

As also illustrated in FIG. 12, the intermediate layer of the multilayer neural network model is formed by stacking multiple layers each including a plurality of neurons with each other. Although forming a large-scale neural network model, in which a large number of neurons and a large number of intermediate layers are disposed, enables an objective variable to be improved in accuracy of approximation by causing the large-scale neural network model to learn a complicated input/output relationship, there is a trade-off relationship between increasing the accuracy of approximation and a size of a scale of the neural network model. Thus, the neural network model of the control device of the internal combustion engine of the vehicle according to the present embodiment is configured and provided after preliminarily considering a compatibility point with high so-called cost effectiveness, the compatibility point balancing both requirements of desired accuracy of approximation and a model scale in consideration of calculation processing capability of the control device 1, a housing size, cost suppression, and the like.

Then, a variable having a causal relationship with an objective variable is set in the input layer as train data on an explanatory variable, and the objective variable is set in the output layer as the train data. After that, machine learning (supervised learning) is performed on the weight w and the bias b to be set to a plurality of neurons in the intermediate layer using a known algorithm such as the error back propagation method. The machine learning enables an input/output relationship of the neural network model to be approximated with high accuracy. The learned model subjected to learning as described above calculates the input/output relationship based on learned contents when the explanatory variable used for the machine learning as the train data is input to the input layer, and then outputs a value of the objective variable based on the input explanatory variable as a result of the calculation.

### Relationship Between Objective Variable and Explanatory Variable

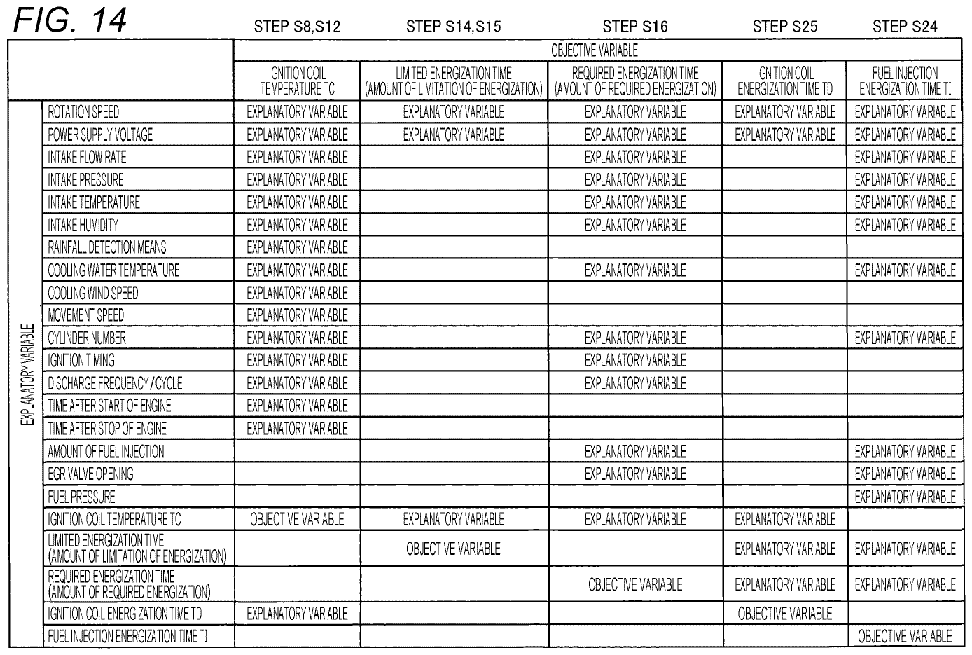

Next, a relationship between the objective variable and the explanatory variable according to the present embodiment will be described with reference to FIG. 14.

FIG. 14 is a correspondence table illustrating a relationship between objective variables and explanatory variables of the first to fifth neural network models according to the first embodiment. FIG. 14 shows an example of an explanatory variable input for estimating (calculating) each objective variable.

As illustrated in FIG. 14, when the ignition coil temperature TC as the objective variable is estimated in the first neural network model, not only the rotation speed NE and the power supply voltage VB described above, but also variables are input to the first neural network model as explanatory variables to perform machine learning on the plurality of neurons in the intermediate layer, the variables being selected from values related to an intake flow rate, intake pressure, intake temperature, intake humidity, rainfall (rainfall detection), cooling water temperature, and cooling wind speed, movement speed of a vehicle, ignition timing, ignition coil energization time (performed value), a frequency of energization/energization cycle, elapsed time after an engine (internal combustion engine) is started, elapsed time after the engine (internal combustion engine) is stopped, and suppliable discharge energy (previously calculated value).

In addition to the explanatory variables described above, examples of explanatory variables that can be further added to the first neural network model include combustion pressure detected by an in-cylinder pressure sensor, lubricating oil temperature, a value related to a crank angle at which each intake valve or exhaust valve of the internal combustion engine is opened or a crank angle at which each intake valve or exhaust valve is closed, an accelerator opening degree, ignition coil temperature TC (previous value), ignition coil energization time, an air-fuel ratio feedback correction coefficient, downstream air-fuel ratio sensor (O2 sensor) voltage, upstream air-fuel ratio sensor (linear air-fuel ratio sensor) voltage, value related to properties (octane number and the like) of fuel to be supplied to the internal combustion engine, an operation state of a radiator fan, torque, the amount of intake, the amount of fuel injection, an air-fuel ratio or an equivalent ratio, a value of pressure in an exhaust pipe, the pressure being associated with exhaust gas recirculation. Then, required variables can be set as explanatory variables of the first neural network model by selecting some or all of the explanatory variables listed above in view of a magnitude of a causal relationship with the ignition coil temperature TC as the objective variable, a size of a scale of a neural network model as described above, easiness of acquisition of variables in the control device 1, and the like.

### Explanatory Variable

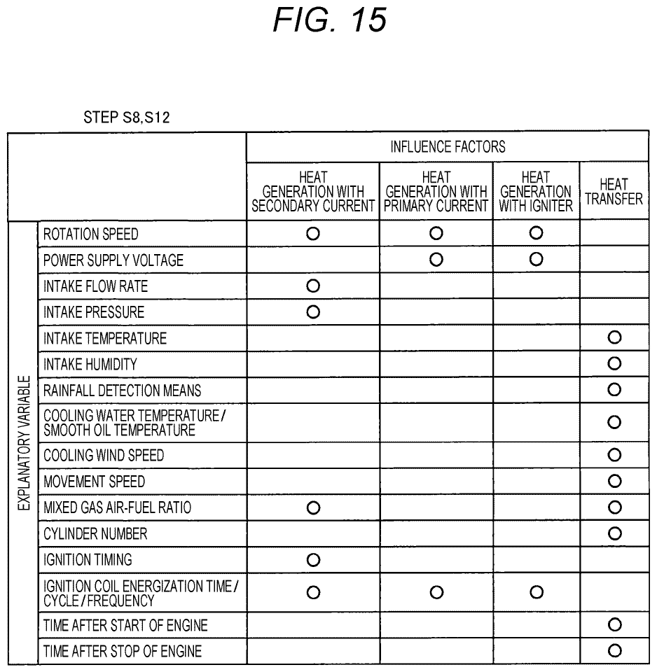

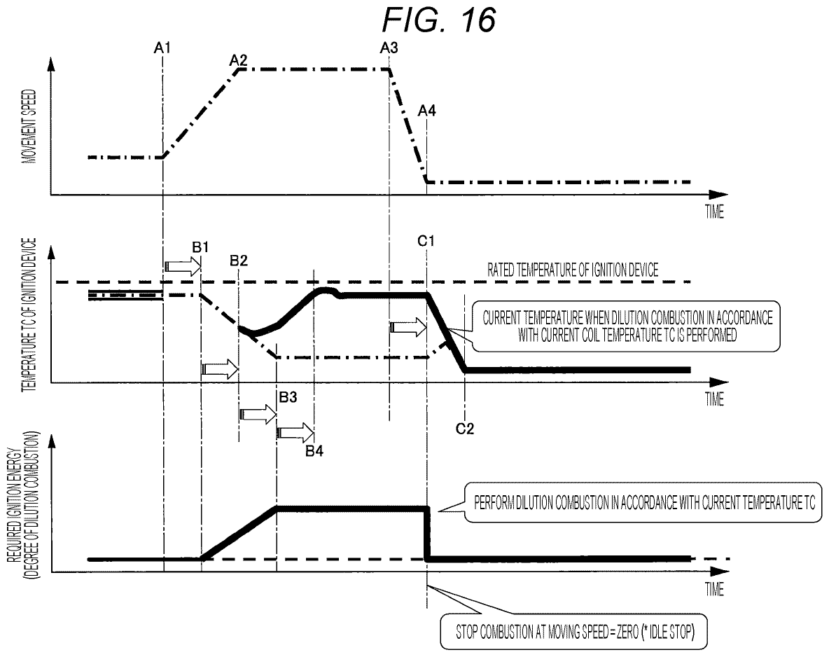

Next, a method for selecting an explanatory variable for estimating the ignition coil temperature (current temperature TC or future temperature TCf) using the first neural network model according to the first embodiment will be described with reference to FIG. 15.

FIG. 15 is a table illustrating an example of variables related to influence factors to be considered when an explanatory variable for estimating the ignition coil temperature using the first neural network model according to the first embodiment is selected.

The influencing factors related to fluctuation of the ignition coil temperature include a factor related to internal heat generation of the ignition coil and a factor related to external heat transfer. FIG. 15 shows the variables for each of which a magnitude of an absolute value of a correlation coefficient with the ignition coil temperature is studied. Then, the variables are selected as the explanatory variables of the first neural network model in descending order of the magnitude of the absolute value of the correlation coefficient, for example.

The internal heat generation of the ignition coil includes heat generation using a secondary current, heat generation using a primary current, and heat generation in the igniter 340 (see FIG. 4). This heat generation is caused by a power loss in an internal circuit of the ignition coil. Thus, a variable having a large correlation coefficient is selected as an explanatory variable for each internal heat generation. Examples of a variable having a large correlation coefficient with heat generation using the secondary current include rotation speed NE, intake flow rate, intake pressure, mixed gas air-fuel ratio, ignition timing, and ignition coil energization time/a frequency of energization/cycle. Examples of a variable having a large correlation coefficient with heat generation due to the primary current and the igniter include the rotation speed NE, the power supply voltage VB, and the ignition coil energization time/the frequency of energization/the cycle.

The external heat transfer of the ignition coil occurs at a contact part outside a housing of the ignition coil 300. Examples of an object in direct contact with the ignition coil 300 include air (atmosphere), an ignition plug, and a cylinder head in an ignition coil of a type in which an ignition coil is disposed adjacent to an ignition plug for each cylinder of the internal combustion engine 100. Thus, a variable having a large correlation coefficient is selected as an explanatory variable for each object in direct contact with the ignition coil 300. Examples of a variable having a large correlation coefficient with the external heat transfer include intake air temperature, intake air humidity, rainfall, cooling water temperature, lubricating oil temperature, cooling wind speed, movement speed of a vehicle, a mixed gas air-fuel ratio, a cylinder number, elapsed time after start of an engine (internal combustion engine), and elapsed time after stop of the engine (internal combustion engine).

An example has been described in the present embodiment, in which the amount of required energization and the amount of limitation of energization for igniting an air-fuel mixture with a spark generated by discharge (ignition) are determined to adjust the amount of energization of the ignition coil. Examples of the discharge (ignition) include discharge that is intermittently performed for one combustion cycle of the internal combustion engine 100 (one ignition for each compression top dead center every two revolutions of the crank), and discharge and ignition that are performed for each compression top dead center and exhaust top dead center. Alternatively, the present invention may be applied to additional discharge in an ignition plug that is performed in a multiple and frequent manner (multiple ignition is performed) in addition to ignition at the top dead center. That is, the amount of energization of the ignition coil for each of ignition at the compression top dead center, ignition per rotation, and multiple ignition may be individually adjusted based on a total amount of the amount of required energization and the amount of limitation of energization for one combustion cycle of the internal combustion engine 100. For example, energization time of the ignition coil at the compression top dead center is set based on the amount of required energization, and energization time of the ignition coil of each of discharge at the exhaust top dead center and discharge with multiple ignition can be set by dividing and calculating a value obtained by subtracting the amount of required energization from a total amount of the amount of limitation of energization for one combustion cycle of the internal combustion engine 100 in accordance with a scheduled frequency of discharge at the exhaust top dead center or multiple ignition. Then, the discharge at the exhaust top dead center or the discharge with multiple ignition is performed on a side at a temperature lower than the temperature at the point where the suppliable discharge energy A and the required discharge energy B cross each other as illustrated in FIG. 8.

### Relationship Among Movement Speed of Vehicle, Ignition Device Temperature, and Ignition Energy

Next, a relationship among movement speed of a vehicle, ignition device temperature, and ignition energy will be described with reference to FIG. 16.

FIG. 16 is a timing chart of the movement speed of the vehicle, the ignition device temperature, and the ignition energy.

The ignition device temperature is mainly affected by heat generated when the ignition coil 300 (see FIG. 4) is energized (coil energized heat generation), temperature around the ignition coil 300 (temperature of the engine head), and wind speed around the ignition device. Thus, the wind speed around the ignition device changes with the movement speed of the vehicle.

As illustrated in FIG. 16, when a vehicle that has been moving by operation at constant speed and a theoretical air-fuel ratio transitions to an acceleration state (movement speed rises) from an A1 time point, for example, the current temperature TC of the ignition device having a thermal time constant starts to decrease from a B1 time point that is delayed in time series from the A1 time point in accordance with increase in relative wind speed proportional to the acceleration. After that, when the vehicle having finished the acceleration transitions to a movement state at constant speed from the A2 time point, a heat balance between heat generation and heat radiation of the ignition device is balanced from a B3 time point that is delayed in time series from the A2 time point, and then the current temperature TC is stabilized. At this time, extending (increasing) the limited energization time of the ignition device based on the current temperature TC decreasing from the B1 time point enables increase in degree of implementation of dilution combustion control (fuel efficiency reduction control) with increase in the required energization time. For example, when the degree of implementation of the dilution combustion control is sequentially increased based on the current temperature TC decreasing from the B1 time point, the current temperature TC starts to rise from the B2 time point that is delayed in time series from the B1 time point in response to the increase in the degree of implementation of the dilution combustion control. Then, the current temperature TC in the implementation of the dilution combustion control (fuel efficiency reduction control) is balanced at a B4 time point that is further delayed in time series from the B3 time point at which the heat balance between the heat generation and the heat dissipation of the ignition device is balanced in the operation at the theoretical air-fuel ratio. Consequently, the current temperature TC in operation under the dilution combustion control is temporarily stabilized after the B4 time point.

As can be easily seen from elapse of the period from the B1 time point to the B4 time point, undershoot of the current temperature TC occurs in accordance with increase in the relative wind speed proportional to the acceleration in a process of acceleration of the vehicle. Consequently, a difference (temperature margin) between the rated temperature of the ignition device and the current temperature TC increases. In other words, when the amount of energization of the ignition coil 300 is increased based on the current temperature TC that decreases with a delay from change in the movement speed of the vehicle, an opportunity loss of the dilution combustion control (fuel efficiency reduction control) due to influence of the delay occurs.

Subsequently to the above, when the vehicle having been moving at a constant speed from the A3 time point that is delayed in time series from the A2 time point in the operation under the dilution combustion control transitions to a deceleration state (movement speed decreases) from the A3 time point, the current temperature TC starts to decrease from a C1 time point that is delayed in time series from the A3 time point in accordance with decrease in the relative wind speed proportional to the deceleration. After that, the vehicle having decelerated transitions from the A4 time point to a movement stop state. At this time, known fuel cut control and idling stop control involving stopping ignition and fuel injection are performed after the A3 time point. The heat generation in the ignition device becomes substantially zero with the stopping ignition, so that the current temperature TC decreases toward outside air temperature after the A4 time point.

### Relationship Among Movement Speed, Ignition Device Temperature, and Ignition Energy in First Embodiment

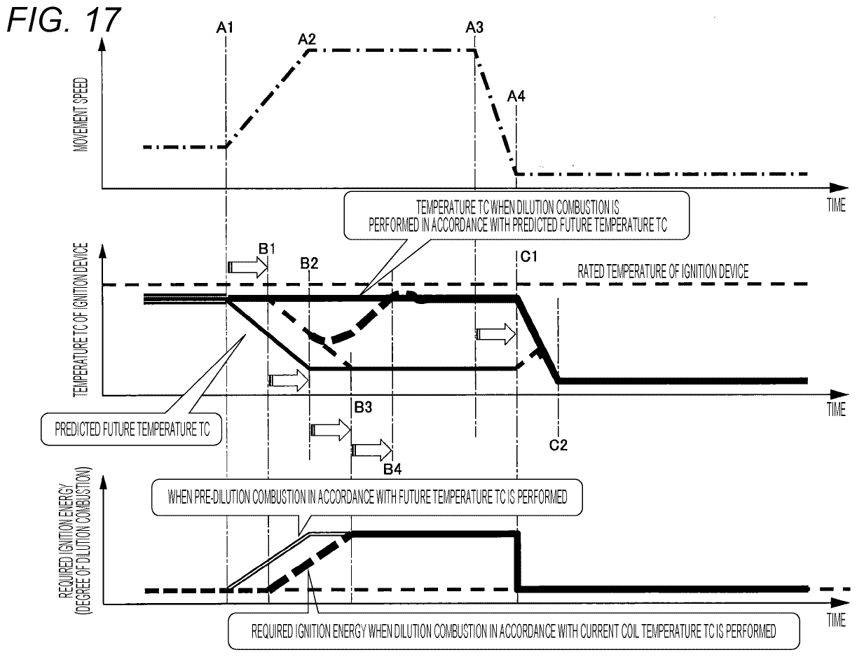

Next, a relationship among movement speed, ignition device temperature, and ignition energy according to the first embodiment will be described with reference to FIG. 17.

FIG. 17 is a timing chart of the movement speed, the current temperature TC of the ignition device, and the ignition energy according to the first embodiment.

As illustrated in FIG. 17, when a vehicle that has been moving by operation at constant speed and a theoretical air-fuel ratio transitions to an acceleration state (movement speed rises) from an A1 time point, for example, the current temperature TC of the ignition device having a thermal time constant starts to decrease from a B1 time point that is delayed in time series from the A1 time point in accordance with increase in relative wind speed proportional to the acceleration. After that, when the vehicle having finished the acceleration transitions to a movement state at constant speed from the A2 time point, a heat balance between heat generation and heat radiation of the ignition device is balanced from a B3 time point that is delayed in time series from the A2 time point, and then the current temperature TC in operation at the theoretical air-fuel ratio is stabilized. At this time, an undershoot (see FIG. 16) of the current temperature TC in a process of accelerating the vehicle can be suppressed in the present embodiment by extending (increasing) the limited energization time of the ignition device based on the future temperature TCf of the ignition device that predicts the current temperature TC decreasing from the B1 time point. As described above, the dilution combustion control (fuel efficiency reduction control) with increase in the required energization time can be performed while the difference (temperature margin) between the rated temperature of the ignition device and the current temperature TC generated when the vehicle accelerates is used without waste in the present embodiment by performing the operation under the dilution combustion control based on the future temperature TCf. As a result, fuel efficiency can be improved.

As described above, the dilution combustion control is performed based on the future temperature TCf while the vehicle is traveling in the present invention, so that the fuel efficiency can be improved without implementing measures to increase a temperature margin, the measures being accompanied by increase in cost in hardware, such as increasing a size of the ignition device to set heat capacity to be large.

### SUMMARY

(1) The control device 1 (internal combustion engine control device) according to the above-described embodiment controls an internal combustion engine 100 for a vehicle, the internal combustion engine 100 including a throttle valve 113 (intake device) that guides intake air into the cylinder 150 through the intake manifold 112 (intake passage), the fuel injection device 134 (fuel supply device) that supplies fuel, and the ignition device that ignites an air-fuel mixture including the intake air and the fuel. The control device 1 includes the ignition device temperature estimation unit 814, the adjuster 813, and the fuel injection amount setting unit 815 (adjuster). The ignition device temperature estimation unit 814 measures or estimates the current temperature TC of the ignition device and estimates the future temperature TCf that is temperature of the ignition device on a future path based on information regarding a current state of the vehicle. The adjuster 813 adjusts a control instruction of at least any one of the ignition device, the fuel injection device 134, and the throttle valve 113 in accordance with the current temperature TC and the future temperature TCf.

Consequently, heat balance of the ignition device can be appropriately controlled in consideration of a driving state of the vehicle on the future path. As a result, increase in size and cost of the ignition device can be suppressed.

(2) The control device 1 (internal combustion engine control device) according to the above-described embodiment is configured such that the amount of required energization of the ignition device is set based on information regarding a current state of a mobile object, and the amount of limitation of energization of the ignition device is determined based on the temperature of the ignition device, rotation speed of the internal combustion engine, and a target air-fuel ratio of the intake device. When the current temperature TC is higher than the future temperature TCf, the amount of limitation of energization is determined based on the future temperature TCf, and when the current temperature TC is equal to or lower than the future temperature TCf, the amount Of limitation of energization is determined based on the current temperature TC. The adjuster 813 sets any one of the amount of limitation of energization and the amount of required energization as a control instruction of the ignition device based on a magnitude relationship between the amount of limitation of energization and the amount of required energization.

Consequently, the target air-fuel ratio can be increased in consideration of the driving state of the vehicle on the future path. As a result, an opportunity to perform dilution combustion control (fuel efficiency reduction control) can be prevented from being lost, and thus fuel efficiency can be improved.

(3) The intake device according to the above-described embodiment is connected to the EGR pipe 180 and the EGR valve 181 (exhaust gas recirculation device) that recirculate an exhaust gas of the internal combustion engine. The control device 1 (internal combustion engine control, device) is configured such that the amount of required control of the EGR valve 181 is set based on information regarding the current state of the mobile object. The amount of required energization of the ignition device is set in accordance with the amount of required control of the EGR valve 181. The adjuster 813 sets any one of the amount of required control and a value obtained by correcting the amount of required control as a control instruction for each of the EGR pipe 180 and the EGR valve 181 based on the magnitude relationship between the amount of limitation of energization and the amount of required energization.

Consequently, an air-fuel ratio can be increased by performing exhaust gas recirculation. As a result, the fuel efficiency can be improved.

(4) The control device 1 (internal combustion engine control device) according to the above-described embodiment is configured such that a required target air-fuel ratio for the air-fuel mixture is set based on the information regarding the current state of the mobile object. The amount of required energization of the ignition device is set in accordance with the required target air-fuel ratio. The adjuster 813 sets any one of the required target air-fuel ratio and a value obtained by correcting the required target air-fuel ratio as a control instruction to the fuel supply device based on the magnitude relationship between the amount of limitation of energization and the amount of required energization.

Consequently, the amount of fuel supply of the fuel supply device can be appropriately adjusted.

(5) The control device 1 (internal combustion engine control device) according to the above-described embodiment is configured such that required opening of the intake device is set based on the information regarding the current state of the mobile object. The amount of required energization of the ignition device is set in accordance with the required opening of the intake device. The adjuster 813 sets any one of the required opening of the intake device and a value obtained by correcting the required opening of the intake device as a control instruction to the intake device based on the magnitude relationship between the amount of limitation of energization and the amount of required energization.

Consequently, the amount of required energization of the ignition device can be appropriately adjusted.

(6) The control system for a mobile object according to the above-described embodiment includes the internal combustion engine control device 1 that controls the internal combustion engine 100 for the mobile object (vehicle), and the communication unit 190 (communication device) that mediates communication between an external device outside the mobile object and the internal combustion engine control device 1. The internal combustion engine 100 includes the throttle valve 113 (intake device) that guides intake air into the cylinder 150 through the intake manifold 112 (intake passage), the fuel injection device 134 (fuel supply device) that supplies fuel, and the ignition device that ignites an air-fuel mixture including the intake air and the fuel. The internal combustion engine control device 1 includes the ignition device temperature estimation unit 814, the adjuster 813, and the current parameter observation unit. The current parameter observation unit includes the rotation speed information generator 86, the intake amount measurement unit 87, the water temperature measurement unit 89, and the like. The ignition device temperature estimation unit 814 measures or estimates the current temperature TC of the ignition device and estimates the future temperature TCf that is temperature of the ignition device on a future path based on information regarding a current state of the vehicle. The adjuster 813 adjusts a control instruction of at least any one of the ignition device, the fuel injection device 134, and the throttle valve 113 in accordance with the current temperature TC and the future temperature TCf. The current parameter observation unit measures or estimates a current parameter related to the current state of the vehicle. The adjuster 813 includes a prediction parameter acquisition unit and a future parameter prediction unit. The prediction parameter acquisition unit acquires a prediction parameter regarding a state of the mobile object (vehicle) on the future path through communication connection to the external device using the communication unit 190. The future parameter prediction unit predicts a plurality of future parameters related to the state of the vehicle on the future path based on the prediction parameter and the current parameter. The ignition device temperature estimation unit 814 estimates the future temperature TCf based on the current temperature TC, a plurality of current parameters, and the plurality of future parameters.

Consequently, heat balance of the ignition device of the ignition coil 300 can be appropriately controlled in consideration of the driving state of the mobile object (vehicle) on the future path. As a result, increase in size and cost of the ignition device can be suppressed.

(7) The prediction parameter according to the above-described embodiment is information regarding a driving state (movement state) of the mobile object on the future path. The ignition device temperature estimation unit 814 measures or estimates the current temperature TC based on the current parameter, and estimates the future temperature TCf based on the prediction parameter.

Consequently, the current temperature TC and the future temperature TCf of the ignition device can be measured or estimated.

(8) The future temperature TCf according to the above-described embodiment is output through the neural network model provided in the ignition device temperature estimation unit 814. The explanatory variables of the neural network model include a parameter selected from prediction parameters, a parameter related to a heat generation part of the ignition device, and a parameter related to heat balance inside and outside the ignition device.

Consequently, the current temperature TC and the future temperature TCf of the ignition device can be estimated.

The present invention is not limited to the embodiments described above and illustrated in the drawings, and various modifications can be made without departing from the gist of the invention described in the scope of claims.

The above-described embodiments have been described in detail to describe the present invention in an easy-to-understand manner, and are not necessarily limited to those having all the described configurations. The configuration of any one of the embodiments can be partially replaced with a configuration of another embodiment, and the configuration of the other embodiment can be added to the configuration of any one of the embodiments. Additionally, another configuration can be added, deleted, and replaced for a part of the configuration of each embodiment.

### REFERENCE SIGNS LIST

1 internal combustion engine control device
10 analog input unit
20 digital input unit
30 A/D converter
40 RAM
50 MPU
60 ROM
70 I/O port
80 output circuit
81 general controller
82 fuel injection controller
83 ignition controller
84 cylinder determination unit
85 angle information generator
86 rotation speed information generator
87 intake amount measurement unit
88 load information generator
89 water temperature measurement unit
90 voltage measurement unit
91 intake controller
100 internal combustion engine
110 air cleaner
111 intake pipe
112 intake manifold
113 throttle valve
113a throttle opening sensor
114 flow rate sensor
115 intake air temperature sensor
120 ring gear
121 crank angle sensor
122 water temperature sensor
123 crank shaft
125 accelerator pedal
126 accelerator position sensor
130 fuel tank
131 fuel pump
132 pressure regulator
133 fuel pipe
134 fuel injection device
140 cylinder pressure sensor
150 cylinder
151 intake valve
152 exhaust valve
160 exhaust manifold
161 three-way catalyst
162 upstream air-fuel ratio sensor
163 downstream air-fuel ratio sensor

1170 piston
180 EGR pipe
181 EGR valve
190 communication unit
200 ignition plug
210 center electrode
220 outer electrode
230 insulator
300, 301 ignition coil
310 primary coil
320 secondary coil
330 DC power supply
340 igniter
350, 360 temperature switch unit
361 temperature detector
500, 501 electric circuit
811 ignition timing setting unit
812 requirement setting unit
813 adjuster
814 ignition device temperature estimation unit
815 fuel injection amount setting unit
816 fuel injection timing setting unit

1. An internal combustion engine control device that controls an internal combustion engine for a mobile object, the internal combustion engine including an intake device that guides intake air into a cylinder through an intake passage, a fuel supply device that supplies fuel, and an ignition device that ignites an air-fuel mixture including the intake air and the fuel, the internal combustion engine control device comprising:
an ignition device temperature estimation unit that measures or estimates a current temperature of the ignition device based on information regarding a current state of the mobile object and estimates a future temperature that is a temperature of the ignition device on a future path; and
an adjuster that adjusts a control instruction of at least any one of the ignition device, the fuel supply device, and the intake device in accordance with the current temperature and the future temperature.

2. The internal combustion engine control device according to claim 1, wherein
the ignition device has an amount of required energization that is set based on information regarding a current state of the mobile object, and an amount of limitation of energization that is determined based on the temperature of the ignition device, rotation speed of the internal combustion engine, and a target air-fuel ratio of the intake device,
the amount of limitation of energization is determined based on the future temperature when the current temperature is higher than the future temperature, and the amount of limitation of energization is determined based on the current temperature when the current temperature is equal to or lower than the future temperature, and
the adjuster sets any one of the amount of limitation of energization and the amount of required energization as a control instruction of the ignition device based on a magnitude relationship between the amount of limitation of energization and the amount of required energization.

3. The internal combustion engine control device according to claim 2, wherein
the intake device is connected to an exhaust gas recirculation device that recirculates an exhaust gas of the internal combustion engine, and an amount of required control of the exhaust gas recirculation device is set based on information regarding the current state of the mobile object,
the amount of required energization of the ignition device is set in accordance with the amount of required control of the exhaust gas recirculation device, and
the adjuster sets any one of the amount of required control and a value obtained by correcting the amount of required control as a control instruction for the exhaust gas recirculation device based on the magnitude relationship between the amount of limitation of energization and the amount of required energization.

4. The internal combustion engine control device according to claim 2, wherein
the air-fuel mixture has a required target air-fuel ratio that is set based on the information regarding the current state of the mobile object,
the amount of required energization of the ignition device is set in accordance with the required target air-fuel ratio, and
the adjuster sets any one of the required target air-fuel ratio and a value obtained by correcting the required target air-fuel ratio as a control instruction to the fuel supply device based on the magnitude relationship between the amount of limitation of energization and the amount of required energization.

5. The internal combustion engine control device according to claim 2, wherein
the intake device has required opening that is set based on the information regarding the current state of the mobile object,
the amount of required energization of the ignition device is set in accordance with the required opening of the intake device, and
the adjuster sets any one of the required opening of the intake device and a value obtained by correcting the required opening of the intake device as a control instruction to the intake device based on the magnitude relationship between the amount of limitation of energization and the amount of required energization.

6. A control system for a mobile object, the control system comprising:
an internal combustion engine control device that controls an internal combustion engine for the mobile object, the internal combustion engine including an intake device that guides intake air into a cylinder through an intake passage, a fuel supply device that supplies fuel, and an ignition device that ignites an air-fuel mixture including the intake air and the fuel; and
a communication device that mediates communication between an external device outside the mobile object and the internal combustion engine control device,
wherein the internal combustion engine control device includes:
an ignition device temperature estimation unit that measures or estimates a current temperature of the ignition device and estimates a future temperature that is a temperature of the ignition device on a future path based on information regarding a current state of the mobile object;
an adjuster that adjusts a control instruction of at least any one of the ignition device, the fuel supply device, and the intake device in accordance with the current temperature and the future temperature; and
a current parameter observation unit that measures or estimates a current parameter related to the current state of the mobile object,
the adjuster includes:
a prediction parameter acquisition unit that acquires a prediction parameter regarding a state of the mobile object on the future path through communication connection to the external device using the communication device; and
a future parameter prediction unit that predicts a plurality of future parameters related to the state of the mobile object on the future path based on the prediction parameter and the current parameter, and
the ignition device temperature estimation unit estimates the future temperature based on the current temperature, the plurality of current parameters, and the plurality of future parameters.

7. The control system for a mobile object according to claim 6, wherein
the prediction parameter is information regarding a movement state of the mobile object on the future path, and
the ignition device temperature estimation unit measures or estimates the current temperature based on the current parameter, and estimates the future temperature based on the prediction parameter.

8. The control system for a mobile object according to claim 6, wherein the future temperature is output through a neural network model provided in the ignition device temperature estimation unit, and the neural network model has explanatory variables that include a parameter selected from the prediction parameter, a parameter related to a heat generation part of the ignition device, and a parameter related to heat balance inside and outside the ignition device.
